(19) United States
(12) Patent Application Publication
(10) Pub. No.: US 2009/0005061 A1
(43) Pub. Date: Jan. 1, 2009

(54) LOCATION QUALITY OF SERVICE INDICATOR

(75) Inventors: Matthew L. Ward, Collegeville, PA (US); Frederic Beckley, Philadelphia, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: TruePosition, Inc., Berwyn, PA (US)

(21) Appl. No.: 11/534,137

(22) Filed: Sep. 21, 2006

Related U.S. Application Data
(63) Continuation-in-part of application No. 11/323,265, filed on Dec. 30, 2005.

(51) Int. Cl. H04Q 7/20

(52) U.S. Cl. 455/456.1; 455/456.3; 455/566; 455/456.5

(57) ABSTRACT

A mobile wireless device is configured to provide a location quality of service indicator (QoSI) indicative of the quality of a calculated location estimation for use by a location-based service. The QoSI may be calculated by the device itself or by a server, such as a location enabling server (LES). The QoSI may be used to represent the predicted location accuracy, availability, latency, precision, and/or yield.

### CROSS REFERENCE

This application is a continuation-in-part of application Ser. No. 11/323,265, filed on Dec. 30, 2005, “DEVICE AND NETWORK ENABLED GEO-FENCING FOR AREA SENSITIVE GAMING ENABLEMENT,” the content of which is hereby incorporated by reference in its entirety.

### TECHNICAL FIELD

The subject matter described herein relates generally to methods and apparatus for locating wireless devices, and enabling, selectively enabling, limiting, denying, or delaying certain functions or services based on the calculated geographic location and a pre-set location area defined by local, regional, or national legal jurisdictions. Wireless devices, also called mobile stations (MS), include those such as used in analog or digital cellular systems, personal communications systems (PCS), enhanced specialized mobile radios (ESMRs), wide-area-networks (WANs), and other types of wireless communications systems. Affected functions or services can include those either local to the mobile station or performed on a landside server or server network. More particularly, but not exclusively, the subject matter described herein relates to a system for providing a Quality of Service indicator (QoSI) on a mobile wireless device, e.g., such as an LDP device of the kind described herein.

### BACKGROUND

This application is related by subject matter to U.S. application Ser. No. 11/198,996, filed Aug. 8, 2005, entitled “Geo-Fencing in a Wireless Location System” (the entirety of which is hereby incorporated by reference), which is a continuation of U.S. application Ser. No. 11/150,414, filed Jun. 10, 2005, entitled “Advanced Triggers for Location Based Service Applications in a Wireless Location System,” which is a continuation-in-part of U.S. application Ser. No. 10/768,587, filed Jan. 29, 2004, entitled “Monitoring of Call Information in a Wireless Location System,” now pending, which is a continuation of U.S. application Ser. No. 09/909,221, filed Jul. 18, 2001, entitled “Monitoring of Call Information in a Wireless Location System,” now U.S. Pat. No. 6,782,264 B2, which is a continuation-in-part of U.S. application Ser. No. 09/539,352, filed Mar. 31, 2000, entitled “Centralized Database for a Wireless Location System,” now U.S. Pat. No. 6,317,604 B1, which is a continuation of U.S. application Ser. No. 09/227,764, filed Jan. 8, 1999, entitled “Calibration for Wireless Location System,” now U.S. Pat. No. 6,184,829 B1.

This application is also related by subject matter to Published U.S. Patent Application No. US20050206566A1, “Multiple Pass Location Processor,” filed on May 5, 2005, which is a continuation of U.S. application Ser. No. 10/915,786, filed Aug. 11, 2004, entitled “Multiple Pass Location Processor,” now U.S. Pat. No. 7,023,383, issued Apr. 4, 2006, which is a continuation of U.S. application Ser. No. 10/414,982, filed Apr. 15, 2003, entitled “Multiple Pass Location Processor,” now U.S. Pat. No. 6,873,290 B2, issued Mar. 29, 2005, which is a continuation-in-part of U.S. patent application Ser. No. 10/106,081, filed Mar. 25, 2002, entitled “Multiple Pass Location Processing,” now U.S. Pat. No. 6,603,428 B2, issued Aug. 5, 2003, which is a continuation of U.S. patent application Ser. No. 10/005,068, filed on Dec. 5, 2001, entitled “Collision Recovery in a Wireless Location System,” now U.S. Pat. No. 6,563,460 B2, issued May 13, 2003, which is a divisional of U.S. patent application Ser. No. 09/648,404, filed on Aug. 24, 2000, entitled “Antenna Selection Method for a Wireless Location System,” now U.S. Pat. No. 6,400,320 B1, issued Jun. 4, 2002, which is a continuation of U.S. patent application Ser. No. 09/227,764, filed on Jan. 8, 1999, entitled “Calibration for Wireless Location System,” now U.S. Pat. No. 6,184,829 B1, issued Feb. 6, 2001.

A great deal of effort has been directed to the location of wireless devices, most notably in support of the Federal Communications Commission's (FCC) rules for Enhanced 911 (E911) Phase (The wireless Enhanced 911 (E911) rules seek to improve the effectiveness and reliability of wireless 911 service by providing 911 dispatchers with additional information on wireless 911 calls. The wireless E911 program is divided into two parts—Phase I and Phase II. Phase I requires carriers, upon valid request by a local Public Safety Answering Point (PSAP), to report the telephone number of a wireless 911 caller and the location of the antenna that received the call. Phase II requires wireless carriers to provide more precise location information, within 50 to 300 meters in most cases. The deployment of E911 has required the development of new technologies and upgrades to local 911 PSAPs, etc.) In E911 Phase II, the FCC's mandate included required location precision based on circular error probability. Network-based systems (wireless location systems where the radio signal is collected at the network receiver) were required to meet a precision of 67% of callers within 100 meters and 95% of callers within 300 meters. Handset-based systems (wireless location systems where the radio signal is collected at the mobile station) were required to meet a precision of 67% of callers within 50 meters and 95% of callers within 100 meters. Wireless carriers were allowed to adjust location accuracy over service areas so the accuracy of any given location estimation could not be guaranteed.

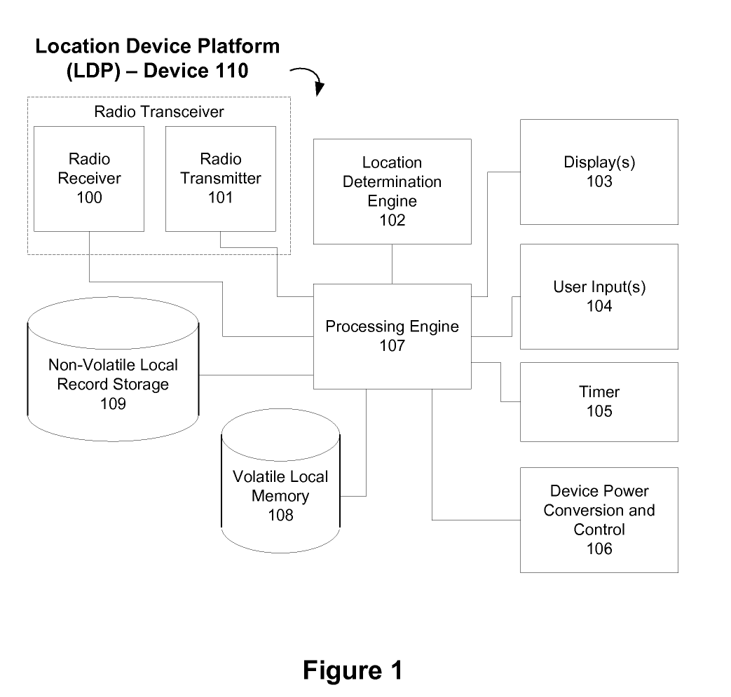

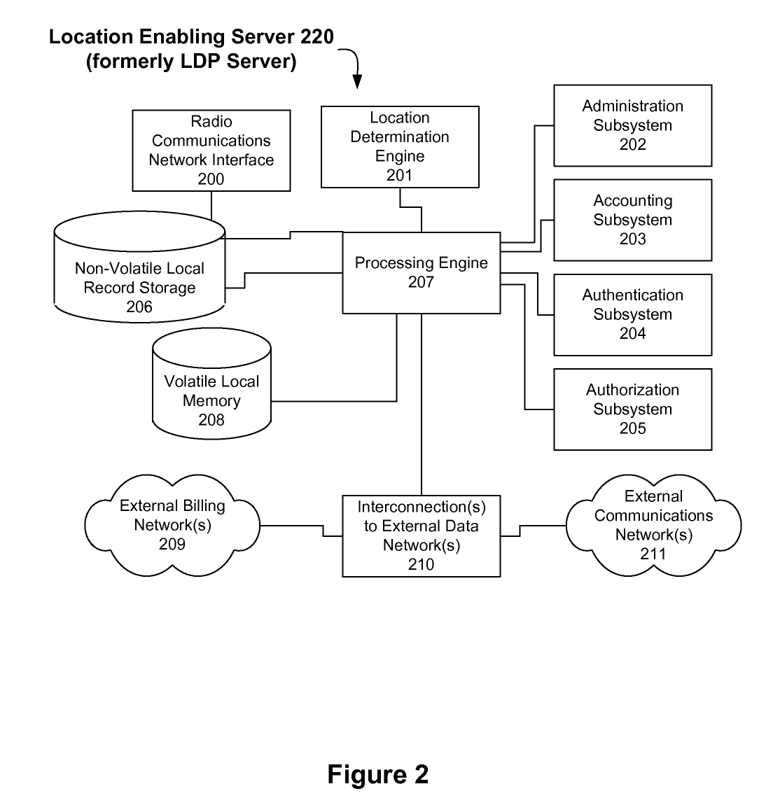

A Location Device Platform (LDP) Device 110 and LES 220 (see FIGS. 1 and 2, respectively) enable location services for any physical item. In one mode, the item is or comprises wireless communications device (cell phone, PDA, etc.) configured for the purposes of wagering. Since wagering is controlled (in the USA) by local or state regulations, the location of legal wagering is typically confined to enclosed areas such as casinos, riverboats, parimutuel tracks, or assigned off-site locations. Use of the LDP capabilities allows for wagering to take place anywhere under the control of a regulatory body.

The LDP device 110 may be used for both purpose-built and general purpose computing platforms with wireless connections and wagering functionality. The LES 220, a location-aware server resident in a telecommunications network, can perform location checking on the wireless LDP device 110 (analogous to existing systems checking of IP addresses or telephony area codes) to determine if wagering functionality can be enabled. The actual wagering application can be resident on the LES 220 or exist on another networked server. The LES 220 can even supply a gaming permission indicator or a geographical location to a live operator/teller.

The location methodology employed by the wireless location system may be dependent on the service area deployed or requirements from the wagering entity or regulatory authority. Network-based location systems include those using POA, PDOA, TOA, TDOA, or AOA, or combinations of these. Device-based location systems may include those using POA, PDOA, TOA, TDOA, GPS, or A-GPS. Hybrids, combining multiple network-based techniques, multiple device-based techniques, or a combination of network and device based techniques, can be used to achieve the accuracy, yield, and latency requirements of the service area or location-based service. The location-aware LES 220 may decide on the location technique to use from those available based on cost of location acquisition.

The LDP device 110 preferably includes a radio communications link (radio receiver and transmitter 100, 101) for communicating with the LES 220. Wireless data communications may include cellular (modem, CPDP, EVDO, GPRS, etc.) or wide-area networks (WiFi, WiMAN/MAX, WiBro, ZigBee, etc.) associated with the location system. The radio communications method can be independent of the wireless location system functionality—for instance, the device may acquire a local WiFi Access Point, but then use GSM to communicate the SSID of the WiFi beacon to the LES 220 for a proximity location.

The LES 220 authenticates, authorizes, bills, and administers the use of the LDP device 110. Preferably, the LES 220 also maintains the service area definitions and wagering rules associated with each service area. The service area may be either a polygon defined by a set of latitude/longitude points or a radius from a central point. The service area may be defined within the location-aware server by interpretation of gaming statutes. Based on the service area definition, the rules, and the calculated location, the LES 220 may grant the wireless device full access, limited access, or no access to gaming services. The LES 220 also preferably supports a geo-fencing application where the LDP device 110 (and the wagering server) is informed when the LDP device 110 enters or leaves a service area. The LES 220 preferably supports multiple limited access indications. Limited access to a wagering service can mean that only simulated play is enabled. Limited access to service can also mean that real multi-player gaming is enabled, but wagering is not allowed. Limited access to service may be determined by time of day or by the location combined with the time of day. Moreover, limited access to service can mean that a reservation for gaming at a particular time and within a prescribed area is made.

The LES 220 can issues a denial of service to both the LDP device 110 and the wagering server. Denial of access can also allow for the provision of directions to where requested gaming is allowed.

The LDP device 110 and LES 220 may allow for all online gaming and wagering activities based on card games, table games, board games, horse racing, auto racing, athletic sports, on-line RPG, and online first person shooter.

It is envisioned, but not required, that the LES 220 could be owned or controlled by a wireless carrier, a gaming organization or a local regulatory board.

We will now briefly summarize two exemplary use cases.

Use Case: Geo-Fencing

In this scenario, the LDP device 110 is a purpose-built gaming model using GSM as the radio link and network-based Uplink-TDOA as the location technique. Handed out to passengers as they arrive at the airport, the LDP device 110 initially supports gaming tutorials, advertisements, and simulated play. When the device enters the service area, it signals the user though audible and visual indicators that the device is now capable of actual wagering. This is an example of a geo-fencing application. Billing and winnings are enabled via credit card or can be charged/awarded to a hotel room number. If the LDP device 110 leaves the area, audible and visual indicators show that the device is now incapable of actual wagering as the LES 220 issues a denial message to the LDP device and wagering server.

Use Case: Access Attempt

In this scenario, the LDP device 110 is a general purpose portable computer with a WiFi transceiver. A wagering application client is resident on the computer. Each time a wagering function is accessed, the LDP device 110 queries the LES 220 for permission. The LES 220 obtains the current location based on the WiFi SSID and power of arrival, compares the location against the service area definition and allows or denies access to the selected wagering application. Billing and winnings are enabled via credit card.

### B. LDP Device

The LDP device 110 is preferably implemented as a location enabling hardware and software electronic platform. The LDP device 110 is preferably capable of enhancing accuracy of a network-based wireless location system and hosting both device-based and hybrid (device and network-based) wireless location applications.

Form Factors

The LDP device 110 may be built in a number of form-factors including a circuit-board design for incorporation into other electronic systems. Addition (or deletion) of components from the Radio Communications Transmitter/Receiver, Location Determination, Display(s), Non-Volatile Local Record Storage, Processing Engine, User Input(s), Volatile Local Memory, Device Power Conversion and Control subsystems or removal of unnecessary subsystems allow the size, weight, power, and form of the LDP to match multiple requirements.

Radio Communications—Transmitter 101

The LDP Radio Communications subsystem may contain one or more transmitters in the form of solid-state application-specific-integrated-circuits (ASICs). Use of a software defined radio may be used to replace multiple narrow-band transmitters and enable transmission in the aforementioned radio communications and location systems. The LDP device 110 is capable of separating the communications radio link transmitter from the transmitter involved in a wireless location transmission under direction of the onboard processor or LES 220.

Radio Communications—Receiver 100

The LDP Radio Communications subsystem may contain one or more receivers in the form of solid-state application-specific-integrated-circuits (ASICs). Use of a wide-band software defined radio may be used to replace multiple narrow-band receivers and enable reception of the aforementioned radio communications and location systems. The LDP device 110 is capable of separating the communications radio link receiver from the receiver used for wireless location purposes under direction of the onboard processor or LES 220. The LDP Radio Communications subsystem may also be used to obtain location-specific broadcast information (such as transmitter locations or satellite ephemeredes) or timing signals from the communications network or other transmitters.

Location Determination Engine 102

The Location Determination Engine, or subsystem, 102 of the LDP device enables device-based, network-based, and hybrid location technologies. This subsystem can collect power and timing measurements, broadcast positioning information and other collateral information for various location methodologies, including but not limited to: device-based time-of-arrival (TOA), forward link trilateration (FLT), Advanced-forward-link-trilateration (AFLT), Enhanced-forward-link-trilateration (E-FLT), Enhanced Observed Difference of Arrival (EOTD), Observed Time Difference of Arrival (O-TDOA), Global Positioning System (GPS) and Assisted GPS (A-GPS). The location methodology may be dependent on the characteristics of the underlying radio communications or radio location system selected by the LDP or LES 220.

The Location Determination subsystem can also act to enhance location in network-based location systems by modifying the transmission characteristics of the LDP device 110 to maximize the device's signal power, duration, bandwidth, and/or delectability (for instance, by inserting a known pattern in the transmitted signal to enable the network-based receiver to use maximum likelihood sequence detection).

Display(s) 103

The display subsystem of the LDP device, when present, may be unique to the LDP and optimized for the particular location-application the device enables. The display subsystem may also be an interface to another device's display subsystem. Examples of LDP displays may include sonic, tactile or visual indicators.

User Input(s) 104

The User Input(s) subsystem 104 of the LDP device, when present, may be unique to the LDP device and optimized for the particular location-application the LDP device enables. The User Input subsystem may also be an interface to another device's input devices.

Timer 105

The timer 105 provides accurate timing/clock signals as may be required by the LDP device 110.

Device Power Conversion and Control 106

The Device Power Conversion and Control subsystem 106 acts to convert and condition landline or battery power for the other LDP device's electronic subsystems.

Processing Engine 107

The processing engine subsystem 107 may be a general purpose computer that can be used by the radio communication, displays, inputs, and location determination subsystems. The processing engine manages LDP device resources and routes data between subsystems and to optimize system performance and power consumption in addition to the normal CPU duties of volatile/non-volatile memory allocation, prioritization, event scheduling, queue management, interrupt management, paging/swap space allocation of volatile memory, process resource limits, virtual memory management parameters, and input/output (I/O) management. If a location services application is running local to the LDP device 110, the processing engine subsystem 107 can be scaled to provide sufficient CPU resources.

Volatile Local Memory 108

The Volatile Local Memory subsystem 108 is under control of the processing engine subsystem 107, which allocates memory to the various subsystems and LDP device resident location applications.

Non-Volatile Local Record Storage 109

The LDP device 110 may maintain local storage of transmitter locations, receiver locations or satellite ephemeredes in non-volatile local record storage 109 through power-down conditions. If the location services application is running local to the LDP device, application specific data and application parameters such as identification, ciphering codes, presentation options, high scores, previous locations, pseudonyms, buddy lists, and default settings can be stored in the non-volatile local record storage subsystem.

### C. Location Aware Application Enabling Server (LES) 220

The LES 220 (see FIG. 2) provides the interface between the wireless LDP devices 110 and networked location-based services applications. In the following paragraphs we describe the components of the illustrative embodiment depicted in FIG. 2. It should be noted that the various functions described are illustrative and are preferably implemented using computer hardware and software technologies, i.e., the LES is preferably implemented as a programmed computer interfaced with radio communications technologies.

Radio Communications Network Interface 200

The LES 220 connects to the LDP device 110 by a data link running over a radio communications network either as a modem signal using systems such as, but not limited to: CDPD, GPRS, SMS/MMS, CDMA-EVDO, or Mobitex. The Radio Communications Network Interface (RCNI) subsystem acts to select and commands the correct (for the particular LDP) communications system for a push operation (where data is sent to the LDP device 110). The RCNI subsystem also handles pull operations where the LDP device 110 connects the LES 220 to initiate a location or location-sensitive operation.

Location Determination Engine 201

The Location Determination Engine subsystem 201 allows the LES 220 to obtain LDP device 110 location via network-based TOA, TDOA, POA, PDOA, AoA or hybrid device and network-based location techniques.

Administration Subsystem 202

The Administration subsystem 202 maintains individual LDP records and services subscription elections. The LES 220 Administration subsystem allows for arbitrary groupings of LDP devices to form services classes. LDP subscriber records may include ownership; passwords/ciphers; account permissions; LDP device 110 capabilities; LDP make, model, and manufacturer; access credentials; and routing information. In the case where the LDP device is a registered device under a wireless communication provider's network, the LES 220 administration subsystem preferably maintains all relevant parameters allowing for LDP access of the wireless communication provider's network.

Accounting Subsystem 203

The LDP Accounting subsystem 203 handles basic accounting functions including maintaining access records, access times, and the location application accessing the LDP device location allowing for charging for individual LDP device and individual LBS services. The Accounting subsystem also preferably records and tracks the cost of each LDP access by the wireless communications network provider and the wireless location network provider. Costs may be recorded for each access and location. The LES 220 can be set with a rules-based system for the minimization of access charges via network and location system preference selection.

Authentication Subsystem 204

The main function of the Authentication subsystem 204 is to provide the LES 220 with the real-time authentication factors needed by the authentication and ciphering processes used within the LDP network for LDP access, data transmission and LBS-application access. The purpose of the authentication process is to protect the LDP network by denying access by unauthorized LDP devices or by location-applications to the LDP network and to ensure that confidentiality is maintained during transport over a wireless carrier's network and wireline networks.

Authorization Subsystem 205

The Authorization subsystem 205 uses data from the Administration and Authentication subsystems to enforce access controls upon both LDP devices and Location-based applications. The access controls implemented may be those specified in Internet Engineering Task Force (IETF) Request for Comment RFC-3693, “Geopriv Requirements,” the Liberty Alliance's Identity Service Interface Specifications (ID-SIS) for Geo-location, and the Open Mobile Alliance (OMA). The Authorization subsystem may also obtain location data for an LDP device before allowing or preventing access to a particular service or Location-based application. Authorization may also be calendar or clock based dependent on the services described in the LDP profile record resident in the administration subsystem. The Authorization system may also govern connections to external billing system and networks, denying connections to those networks that are not authorized or cannot be authenticated.

Non-Volatile Local Record Storage 206

The Non-Volatile Local Record Storage of the LES 220 is primarily used by the Administration, Accounting, and Authentication subsystems to store LDP profile records, ciphering keys, WLS deployments, and wireless carrier information.

Processing Engine 207

The processing engine subsystem 207 may be a general purpose computer. The processing engine manages LES resources and routes data between subsystems.

Volatile Local Memory 208

The LES 220 has a Volatile Local Memory store composed of multi-port memory to allow the LES 220 to scale with multiple, redundant processors.

External Billing Network(s) 209

Authorized External billing networks and billing mediation system may access the LDP accounting subsystem database through this subsystem. Records may also be sent periodically via a pre-arranged interface.

Interconnection(s) to External Data Network(s) 210

The interconnection to External Data networks is designed to handle conversion of the LDP data stream to external LBS applications. The interconnection to External Data networks is also a firewall to prevent unauthorized access as described in the Internet Engineering Task Force (IETF) Request for Comment RFC-3694, “Threat Analysis of the Geopriv Protocol.” Multiple access points resident in the Interconnection to External Data Networks subsystem 210 allow for redundancy and reconfiguration in the case of a denial-of-service or loss of service event. Examples of interconnection protocols supported by the LES 220 include the Open Mobile Alliance (OMA) Mobile-Location-Protocol (MLP) and the Parlay X specification for web services; Part 9: Terminal Location as Open Service Access (OSA); Parlay X web services; Part 9: Terminal location (also standardized as 3GPP TS 29.199-09).

External Communications Network(s) 211

External Communications Networks refer to those networks, both public and private, used by the LES 220 to communicate with location-based applications not resident on the LES 220 or on the LDP device 110.

### D. System/Process for Gaming

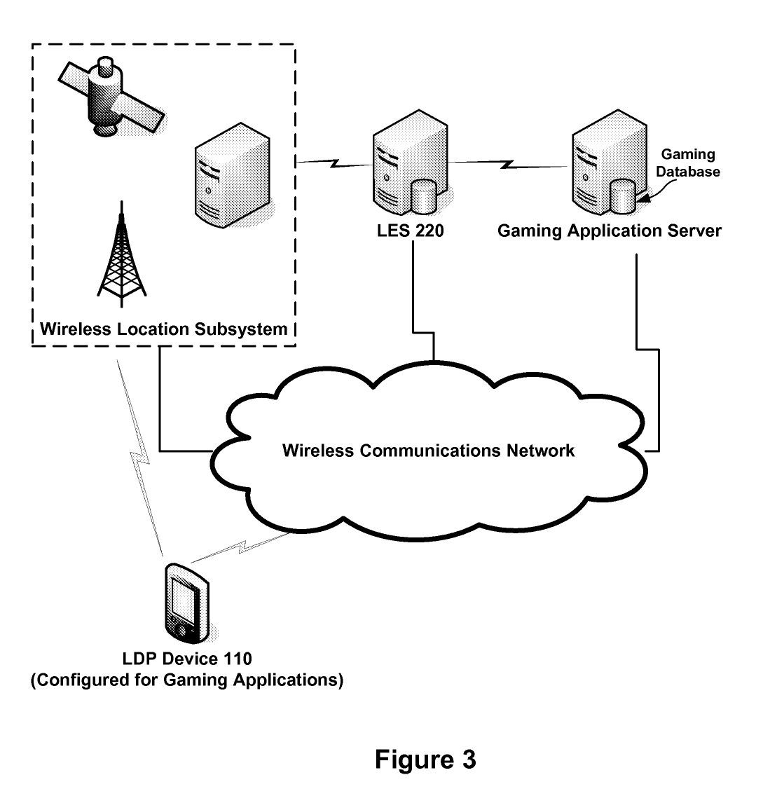

FIG. 3 illustrates a system in accordance with one embodiment of the present invention. As shown, such a system includes one or more LDP devices 110 and an LES 220. The LDP devices 110 may be configured for gaming applications of the type that are typically regulated by state and local governmental agencies. As discussed above, an LDP device may comprise a conventional mobile computing device (e.g., PDA), a mobile digital phone, etc., or may be a special purpose device dedicated to gaming. The LDP device 110 has the capability to provide a user with wireless access to an Internet-based gaming application server. Such access may be provided via a wireless communications network (cellular, WiFi, etc.), as shown. In this implementation of the system, the gaming application server includes or is coupled to a database of gaming information, such as information describing the geographic regions where wagering is permitted.

As shown in FIG. 3, the LES 220 and Gaming Application Server are operatively coupled by a communications link, so that the two devices may communicate with one another. In this embodiment, the LES 220 is also operatively coupled to a wireless location system, which, as discussed herein, may be any kind of system for determining the geographic location of the LDP devices 110. It is not necessary that the LDP devices be located with the precision required for emergency (e.g., E911) services, but only that they be located to the extent necessary to determine whether the devices are in an area where wagering is permitted.

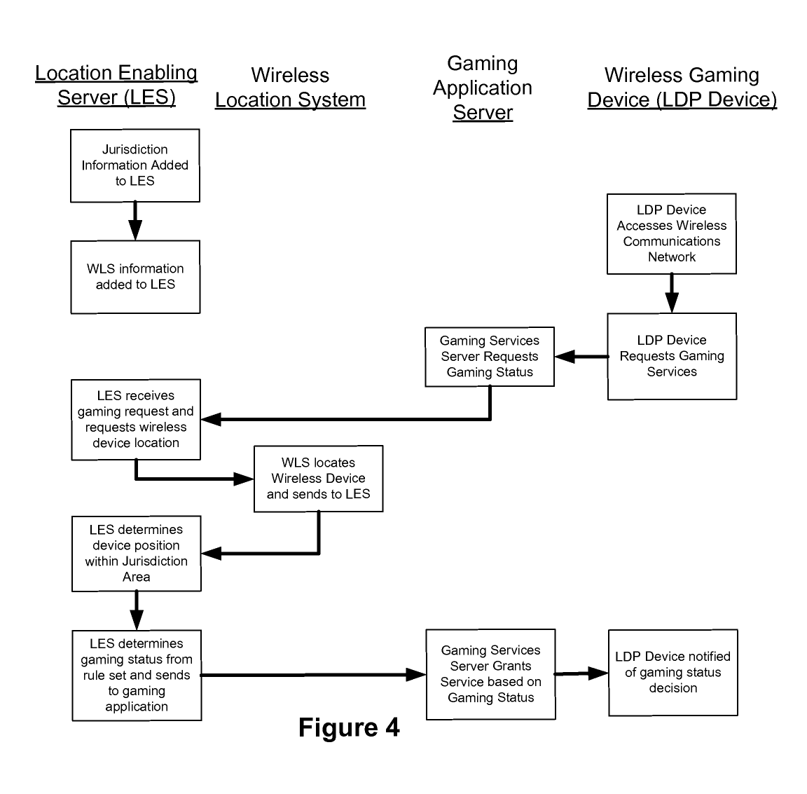

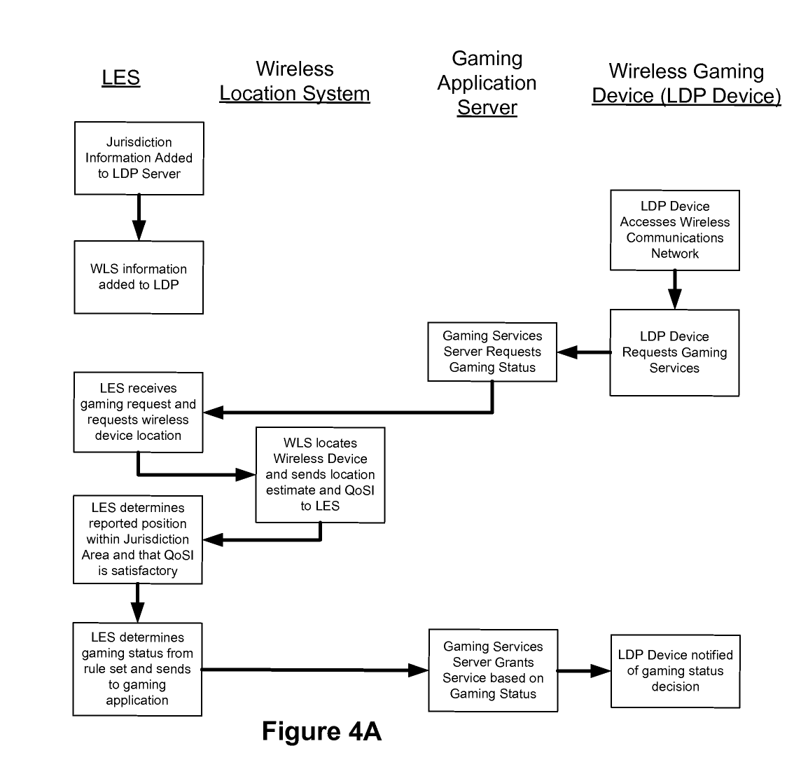

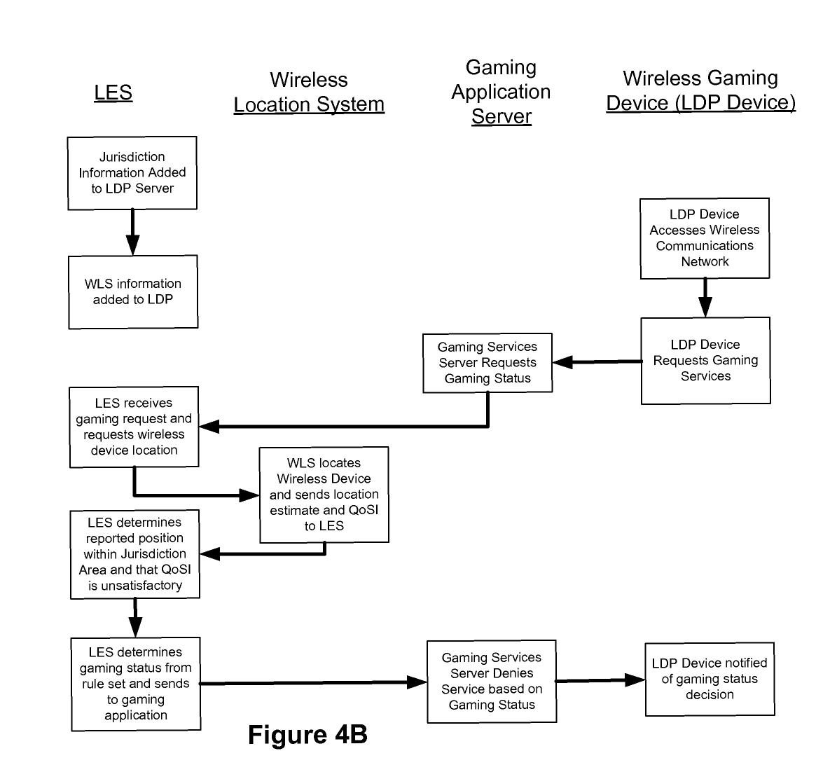

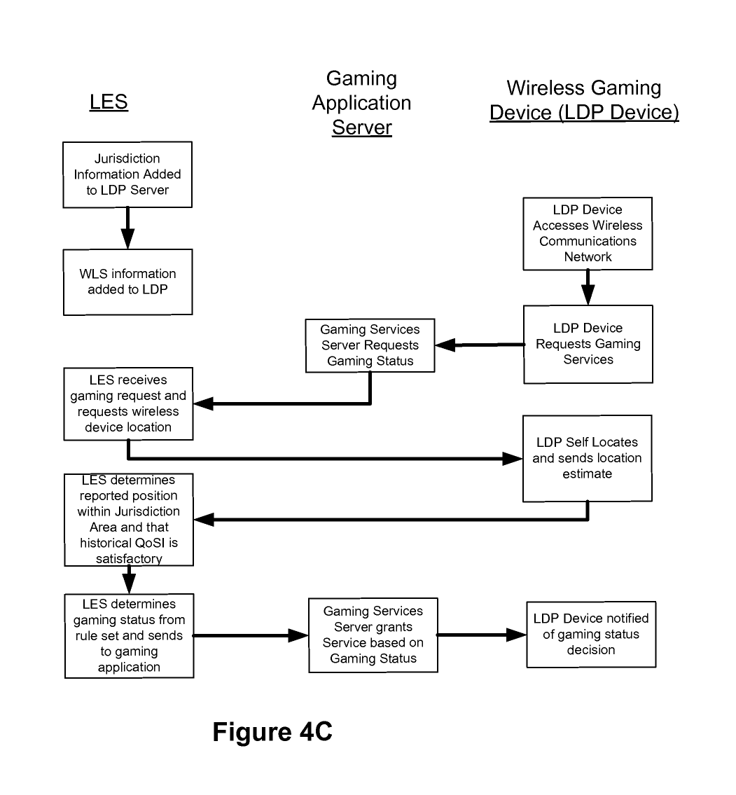

Referring now to FIG. 4, in one exemplary implementation of the described system, the LES is provided with gaming jurisdictional information as well as information provided by the wireless location system. The precise details of what information is provided to the LES will depend upon the precise details of what kinds of services the LES is to provide.

As shown in FIG. 4, the LDP device accesses the wireless communications network and requests access to gaming services. This request is routed to the gaming application server, and the gaming application server in turn requests location information from the LES 220. The LES requests the WLS to locate the LDP device, and the WLS returns the location information to the LES 220. In this implementation of the invention, the LES determines that the LDP device is within a certain predefined jurisdictional area, and then determines whether gaming/wagering services should be provided (alternatively, this determination could be made the responsibility of the gaming application server). This information is provided to the gaming application server, and the gaming application server notifies the LDP device of the determined gaming status decision (i.e., whether gaming services will or will not be provided).

### E. Other Embodiments

### LDP Power Savings Through Selective Awake Mode

Wireless devices typically have three modes of operation to save battery life: sleep, awake (listen), and transmit. In the case of the LDP device 110, a fourth state, locate, is possible. In this state, the LDP device 110 comes first to the awake state. From received data or external sensor input, the LDP device determines if activation of the Location Determination Engine or Transmission subsystem is required. If the received data or external sensor input indicates a location transmission is not needed, then the LDP device 110 powers neither the location determination or transmission subsystems and returns to the minimal power drain sleep mode. If the received data or external sensor input indicates a location transmission is needed only if the device position has changed, then the LDP device 110 will perform a device-based location and returns to the minimal power drain sleep mode. If the received data or external sensor input indicates a location transmission is necessary, then the LDP device 110 may perform a device-based location determination, activate the transmitter, send the current LDP device 110 location (and any other requested data) and return to the minimal power drain sleep mode. Alternatively, if the received data or external sensor input indicates a location transmission is necessary, then the LDP device 110 may activate the transmitter, send a signal (optimized for location) to be located by network-means (the LDP device 110 may send any other requested data at this time) and then return to the minimal power drain sleep mode.

Invisible Roaming for Non-Voice Wireless LDPs

For LDP devices using cellular data communications, it is possible to provision the LDP devices for minimal impact to existing cellular authentication, administration, authorization and accounting services. In this scenario, a single LDP platform is distributed in each cellular base station footprint (within the cell-site electronics). This single LDP device 110 is then registered normally with the wireless carrier. All other LDPs in the area would then use SMS messages for communication with the LES 220 (which has its own authentication, administration, authorization and accounting services) based on the single LDP ID (MIN/ESN/IMSI/TMSI) to limit HLR impact. A server would use the payload of the SMS to determine both the true identity of the LDP and also the triggering action, location or attached sensor data.

SMS Location Probes Using a Known Pattern Loaded into the LDP

Using SMS messages with a known pattern of up to 190 characters in a deployed WLS control channel location architecture or A-bis monitored system the LDP device 110 can enhance the location of an SMS transmission. Since characters are known, the encryption algorithm is known, the bit pattern can be generated and the complete SMS message is available for use as an ideal reference by signal processing to remove co-channel interference and noise to increase the precision possible in a location estimation.

Location Data Encryption for Privacy, Distribution and Non-Repudiation.

A method for enforcement of privacy, re-distribution and billing non-repudiation using an encryption key server based in the LES 220 may be employed. In this method, the LES 220 would encrypt the location record before delivery to any outside entity (the master gateway). The gateway can either open the record or pass the protected record to another entity. Regardless of the opening entity, a key would have to be requested from the LES 220 key server. The request for this key (for the particular message sent) means that the “private” key “envelope’ was opened and the location sequence number (a random number allocated by the LES 220 to identify the location record) read by the entity. The LES 220 would then deliver a “secret” key and the subscriber's location under the same “private” key repeating the location sequence number to allow reading of the location record. In this manner subscriber privacy is enforced, gateways can redistribute location records without reading and recording the data, and receipt of the record by the final entity is non-reputable.

LDP Location with Only a Network-Based Wireless Location System

An LDP device 110 not equipped with a device-based location determination engine can report its position in a non-network-based WLS environment to a LES 220 equipped with an SMSC. At the highest level, the LDP device 110 can report the System ID (SID or PLMN) number or Private System ID (PSID) so the WLS can make the determination that the LDP is in (or out) of a WLS equipped system. The neighbor (MAHO) list transmitted as a series of SMS messages on the control channel could give rough location in a friendly carrier network that has not yet been equipped with a WLS. Reverse SMS allows for the WLS to reprogram any aspect of the LDP device. If the LDP device 110 is in a network-based WLS equipped area, the LDP device 110 can then offer higher levels of accuracy using the network-based WLS.

Automatic Transmitter Location Via LDP with Network Database

If the LDP device 110 radio communications subsystem is designed for multi-frequency, multi-mode operation or if the LDP device 110 is provided with connection to external receivers or sensors, the LDP device 110 becomes a location-enabled telemetry device. In a particular application, the LDP device 110 uses the radio communications subsystem or external receiver to locate radio broadcasts. Reception of such broadcasts, identified by the transmission band or information available from the broadcast, triggers the LDP device 110 to establish a data connection to the LES 220, perform a device-based location or begin a location-enhanced transmission for use by the LES 220 or other network-based server.

One exemplary use of this LDP device 110 variant is as a networked radar detector for automobiles or as a WiFi hotspot locator. In either case, the LES 220 would record the network information and location for delivery to external location-enabled applications.

Use of Externally Derived Precision Timing for Scheduling Communications

Battery life may be a key enabler for at least some applications of autonomous location specific devices. In addition, the effort associated with periodically charging or replacing batteries in a location specific device is anticipated to be a significant cost driver. A device is considered to have 3 states: active, idle, sleep.

Active=in communication with the network

Idle=in a state capable of entering the active state

Sleep=a low power state

The power consumption in the active state is driven by the efficiency of digital and RF electronics. Both of these technologies are considered mature and their power consumption is considered to be already optimized. The power consumption in the sleep mode is driven by the amount of circuitry active during the sleep state. Less circuitry means less power consumption. One method of minimizing power consumption is to minimize the amount of time spent in the idle state. During the idle state, the device must periodically listen to the network for commands (paging) and if received enter the active state. In a standard mobile station (MS), the amount of time spent in the idle state is minimized by restricting the when the paging commands can occur for any particular mobile station.

This aspect of the invention utilizes an absolute external time reference (GPS, A-GPS, or information broadcast over a cellular network) to precisely calibrate the location specific client device's internal time reference. An internal temperature sensing device would enable the device to temperature compensate its own reference. The GPS or A-GPS receiver can be part of the location determination engine of the LDP device 110 used for device-based location estimation.

Given that the location specific device has a precise time reference, the network can schedule the device to enter the idle mode at a precise time thereby maximizing the amount of time spent in the lowest power state. This method will also minimize unsuccessful attempts to communicate with a device in sleep mode thereby minimizing load on the communication network.

Speed, Time, Altitude, Area Service

The LDP device functionality may be incorporated into other electronic devices. As such, the LDP device, a location-aware device with radio communications to an external server with a database of service parameters and rules for use, can be used to grant, limit or deny service on the basis of not only location within a service area, but also on the basis of time, velocity, or altitude for a variety of electronic devices such as cell phones, PDAs, radar detectors, or other interactive systems. Time includes both time-of-day and also periods of time so duration of a service can be limited.

Intelligent Mobile Proximity

The LDP device 110 may be paired with another LDP device to provide intelligent proximity services where the granting, limiting, or denial of services can be based on the proximity of the LDP pair. For instance, in an anti-theft application, an LDP device 110 could be incorporated into an automobile while other LDPs would be incorporated into the car radio, navigation system, etc. By registering the set of LDP devices as paired in the LES 220, and setting triggering conditions for location determination based on activation or removal, an anti-theft system is created. In the case of unauthorized removal, the LDP device 110 in the removed device could either deny service or allow service while providing location of the stolen device incorporating the LDP device.

### F. Location Techniques

### Network-Based, Device-Based and Hybrid

Each wireless (radio) location system comprises a transmitter and receiver. The transmitter creates the signal of interest [s(t), which is collected and measured by the receiver. The measurement of the signal of interest may take place at either the wireless device or the network station. The transmitter or the receiver can be in motion during the signal measurement interval. Both may be in motion if the movements of either (or both) can be precisely defined a priori.

Network-Based Location Techniques

When the measurement takes place at the network (a geographically distributed set of one or more receivers or transceivers), the location system is known as network-based. Network-based wireless location systems can use TOA, TDOA, AOA, POA, and PDOA measurements, often hybridized with two or more independent measurements being included in the final location calculation. The networked receivers or transceivers are known by different names, including Base Stations (cellular), Access Points (Wireless Local Access Networks), Readers (RFID), Masters (Bluetooth) or Sensors (UWB).

Since, in a network-based system, the signal being measured originates at the mobile device, network-based systems receive and measure the signal's time of arrival, angle of arrival, or signal strength. Sources of location error in a network-based location system include: network station topology, signal path loss, signal multipath, co-channel signal interference and terrain topography.

Network station topology can be unsuitable for a network-based location technique with sites in a line (along a roadway) or sites with few neighbors.

Signal path loss can be compensated for by longer sampling periods or using a higher transmit power. Some radio environments (wide area, multiple access spread spectrum systems such as IS-95 CDMA and 3GPP UMTS) have a hear-ability issue due to the lower transmit powers allowed.

Multipath signals, caused by constructive and destructive interference of reflected, non-line-of-sight signal paths will also affect location accuracy and yield of a network-based system, with dense urban environments being especially problematic. Multipath may be compensated for by use of multiple, separated receive antennas for signal collection and post-collection processing of the multiple received signals to remove time and frequency errors from the collected signals before location calculation.

Co-channel signal interference in a multiple access radio environment can be minimized by monitoring of device specific features (example: color-code) or by digital common mode filtering and correlation between pairs of collected signals to remove spurious signal components.

Network-Based—TOA

A Network-based Time-of-Arrival system relies on a signal of interest being broadcast from the device and received by the network station. Variants of Network-based TOA include those summarized below.

Single Station TOA

A range measurement can be estimated from the round-trip time of a polling signal passed between and then returned between transceivers. In effect this range measurement is based on the TOA of the returned signal. Combining the range estimate with the known location of the network node provides a location estimate and error estimate. Single station TOA is useful in hybrid systems where additional location information such as angle-of-arrival or power-of-arrival is available.

An example of the commercial application of the single station TOA technique is found in the CGI+TA location method described in ETSI Technical Standards for GSM: 03.71, and in Location Services (LCS); Functional description; Stage 2_{—}23.171 by the 3rd Generation Partnership Project (3GPP).

Synchronous Network TOA

Network-based TOA location in a synchronous network uses the absolute time of arrival of a radio broadcast at multiple receiver sites. Since signals travel with a known velocity, the distance can be calculated from the times of arrival at the receivers. Time-of-arrival data collected at two receivers will narrow a position to two points, and TOA data from a receiver is required to resolve the precise position. Synchronization of the network base stations is important. Inaccuracy in the timing synchronization translates directly to location estimation error. Other static sources of error that may be calibrated out include antenna and cabling latencies at the network receiver.

A possible future implementation of Synchronous Network TOA, when super-high accuracy (atomic) clocks or GPS-type radio time references achieve affordability and portability, is for the transmitter and receivers to be locked to a common time standard. When both transmitters and receivers have timing in common, the time-of-flight can be calculated directly and the range determined from the time-of-flight and speed of light.

Asynchronous Network TOA

Network-based TOA location in an asynchronous network uses the relative time of arrival of a radio broadcast at the network-based receivers. This technique requires that the distance between individual receiver sites and any differences in individual receiver timing be known. The signal time-of-arrival can then be normalized at for receiver site, leaving only the a time-of-flight between the device and each receiver. Since radio signals travel with a known velocity, the distance can be calculated from derived, normalized time-of-arrivals at the receivers. Time-of-arrival data collected from three of more receivers will be used to resolve the precise position.

Network-Based TDOA

In a network-based (uplink) time-difference-of-arrival wireless location system, the transmitted signal of interest is collected, processed, and time-stamped with great precision at multiple network receiver/transceiver stations. The location of each network station, and thus the distance between stations, is known precisely. The network receiver stations time stamping requires either highly synchronized with highly stable clocks or that the difference in timing between receiver station is known.

A measured time difference between the collected signals from any pair of receiver stations can be represented by a hyperbolic line of position. The position of the receiver can be determined as being somewhere on the hyperbolic curve where the time difference between the received signals is constant. By iterating the determination of the hyperbolic line of position between every pair of receiver stations and calculating the point of intersection between the hyperbolic curves, a location estimation can be determined.

Network-Based AoA

The AOA method uses multiple antennas or multi-element antennae at two or more receiver sites to determine the location of a transmitter by determining the incident angle of an arriving radio signal at each receiver site. Originally described as providing location in an outdoor cellular environment, see U.S. Pat. No. 4,728,959, “Direction Finding Localization,” the AoA technique can also be used in an indoor environment using Ultrawideband (UWB) or WiFi (IEEE802.11) radio technologies.

Network-Based POA

Power of arrival is a proximity measurement used between a single network node and wireless device. If the system consists of transceivers, with both a forward and reverse radio channel available between the device and network node, the wireless device may be commanded to use a certain power for transmission, otherwise the power of the device transmitter should be known a priori. Since the power of a radio signal decreases with range (from attenuation of radio waves by the atmosphere and the combined effects of free space loss, plane earth loss, and diffraction losses), an estimate of the range can be determined from the received signal. In simplest terms, as the distance between transmitter and receiver increases, the radiated radio energy is modeled as if spread over the surface of a sphere. This spherical model means that the radio power at the receiver is decreased by the square of the distance. This simple POA model can be refined by use of more sophisticated propagation models and use of calibration via test transmissions at likely transmission sites.

Network-Based POA Multipath

This power-of-arrival location technology uses features of the physical environment to locate wireless devices. A radio transmission is reflected and absorbed by objects not on the direct line-of-sight on the way to the receiver (either a network antenna or device antenna), causing multipath interference. At the receiver, the sum of the multiple, time delayed, attenuated copies of the transmission arrive for collection.

The POA multipath fingerprinting technique uses the amplitude of the multipath degraded signal to characterize the received signals for comparison against a database of amplitude patterns known to be received from certain calibration locations.

To employ multipath fingerprinting, an operator calibrates the radio network (using test transmissions performed in a grid pattern over the service area) to build the database of amplitude pattern fingerprints for later comparison. Periodic re-calibration is required to update the database to compensate for changes in the radio environment caused by seasonal changes and the effects of construction or clearances in the calibrated area.

Network-Based PDOA

Power-difference-of-arrival requires a one-to-many arrangement with either multiple sensors and a single transmitter or multiple transmitters and a single sensor. PDOA techniques require that the transmitter power and sensor locations be known a priori so that power measurements at the measurement sensors may be calibrated for local (to the antenna and sensor) amplification or attenuation.

Network-Based Hybrids

Network-based systems can be deployed as hybrid systems using a mix of solely network-based or one of network-based and device-based location technologies.

Device-Based Location Techniques

The device-based receivers or transceivers are known by different names: Mobile Stations (cellular), Access Points (Wireless Local Access Networks), transponders (RFID), Slaves (Bluetooth), or Tags (UWB). Since, in a device-based system. the signal being measured originates at the network, device-based systems receive and measure the signal's time of arrival or signal strength. Calculation of the device location may be performed at the device or measured signal characteristics may be transmitted to a server for additional processing.

Device-Based TOA

Device-based TOA location in a synchronous network uses the absolute time of arrival of multiple radio broadcasts at the mobile receiver. Since signals travel with a known velocity, the distance can be calculated from the times of arrival either at the receiver or communicated back to the network and calculated at the server. Time of arrival data from two transmitters will narrow a position to two points, and data from a third transmitter is required to resolve the precise position. Synchronization of the network base stations is important. Inaccuracy in the timing synchronization translates directly to location estimation error. Other static sources of error that may be calibrated out include antenna and cabling latencies at the network transmitter.

A possible future implementation of device-based Synchronous Network TOA, when super-high accuracy (atomic) clocks or GPS-type radio time references achieve affordability and portability, is for the network transmitter and receivers to both be locked to a common time standard. When both transmitters and receivers have timing in common, the time-of-flight can be calculated directly and the range determined from the time-of-flight and speed of light.

Device-Based TDOA

Device-based TDOA is based at collected signals at the mobile device from geographically distributed network transmitters. Unless the transmitters also provide (directly or via broadcast) their locations or the transmitter locations are maintained in the device memory, the device cannot perform the TDOA location estimation directly, but must upload the collected signal related information to a landside server.

The network transmitters stations signal broadcasting requires either transmitter synchronization with highly stable clocks or that the difference in timing between transmitter stations is known to the location determination engine located either on the wireless device or the landside server.

Commercial location systems using device-based TDOA include the Advanced Forward Link Trilateration (AFLT) and Enhanced Forward Link Trilateration (EFLT) (both standardized in ANSI standard IS-801) systems used as a medium accuracy fallback location method in CDMA (ANSI standard IS-95, IS-2000) networks.

Device-Based Observed Time Difference

The device-based Observed Time Difference location technique measuring the time at which signals from the three or more network transmitters arrive at two geographically dispersed locations. These locations can be a population of wireless handsets or a fixed location within the network. The location of the network transmitters must be known a priori to the server performing the location calculation. The position of the handset is determined by comparing the time differences between the two sets of timing measurements.

Examples of this technique include the GSM Enhanced Observed Time Difference (E-OTD) system (ETSI GSM standard 03.71) and the UMTS Observed Time Difference of Arrival (OTDOA) system. Both EOTD and OTDOA can be combined with network TOA or POA measurements for generation of a more accurate location estimate.

Device-Based TDOA—GPS

The Global Positioning System (GPS) is a satellite-based TDOA system that enables receivers on the Earth to calculate accurate location information. The system uses a total of 24 active satellites with highly accurate atomic clocks placed in six different but equally spaced orbital planes. Each orbital plane has four satellites spaced equidistantly to maximize visibility from the surface of the earth. A typical GPS receiver user will have between five and eight satellites in view at any time. With four satellites visible, sufficient timing information is available to be able to calculate the position on Earth.

Each GPS satellite transmits data that includes information about its location and the current time. All GPS satellites synchronize operations so that these repeating signals are transmitted at effectively the same instant. The signals, moving at the speed of light, arrive at a GPS receiver at slightly different times because some satellites are further away than others. The distance to the GPS satellites can be determined by calculating the time it takes for the signals from the satellites to reach the receiver. When the receiver is able to calculate the distance from at least four GPS satellites, it is possible to determine the position of the GPS receiver in three dimensions.

The satellite transmits a variety of information. Some of the chief elements are known as ephemeris and almanac data. The ephemeris data is information that enables the precise orbit of the satellite to be calculated. The almanac data gives the approximate position of all the satellites in the constellation and from this the GPS receiver is able to discover which satellites are in view.

$$x ( t ) = {\sum }_{i} {a}_{i} {D}_{i} ( t ) {CA}_{i} ( t , {t}_{i}^{0} ) sin ( 2 π {f}_{i} + {φ}_{i} ) .$$

where:

i: satellite number

ai: carrier amplitude

Di: Satellite navigation data bits (data rate 50 Hz)

CAi: C/A code (chipping rate 1.023 MHz)

t: time

ti0: C/A code initial phase

fi: carrier frequency

φi: carrier phase

n: noise

w: interference

Device-based Hybrid TDOA—A-GPS

Due to the long satellite acquisition time and poor location yield when a direct line-of-sight with the GPS satellites cannot be obtained, Assisted-GPS was disclosed by Taylor (see U.S. Pat. No. 4,445,118, “Navigation system and method”).

Wireless Technologies for Location

Broadcast Location Systems

Location systems using dedicated spectrum and comprising geographically dispersed receiver networks and a wireless transmitter ‘tag’ can be used with the present invention as can systems supplying timing signals via geographically dispersed networks of transmitting beacons with the LDP device 110 acting as a receiver or transceiver unit. The LDP device 110 is well suited to be either the transmitter tag or receiver unit for such a wireless system and may use such networks dependent on service area, accessibility and pricing of the location service. In the case of a location network operating in a dedicated spectral band, the LDP device 110 could use its ability to utilize other radio communications networks to converse with the LES 220 and landside location applications. Examples of these broadcast location system include the Lo-jack vehicle recovery system, the LORAN system, and the Rosum HDTV transmitter-based, E-OTD-like system.

Cellular

Wireless (Cellular) systems based on AMPS, TDMA, CDMA, GSM, GPRS, and UMTS all support the data communications link required for the present invention. Cellular location systems and devices for enhancing cellular location techniques have been taught in detail in TruePosition's United States patents. These patents cover various location approaches, including but not limited to AoA, AoA hybrids, TDOA, TDOA hybrids including TDOA/FDOA, A-GPS, hybrid A-GPS. Many of the described technologies are now in commercial service.

Local and Wide Area Networks

These wireless systems were all designed as purely digital data communications systems rather than voice-centric systems with data capabilities added on as a secondary purpose. Considerable overlap in radio technologies, signal processing techniques, and data stream formats has resulted from the cross pollination of the various standards groups involved. The European Telecommunications Standards Institute (ETSI) Project for Broadband Radio Access Networks (BRAN), the Institute of Electrical and Electronics Engineers (IEEE), and the Multimedia Mobile Access Communication Systems (MMAC) in Japan (Working Group High Speed Wireless Access Networks) have all acted to harmonize the various systems developed.

In general, WLAN systems that use unlicensed spectrum operate without the ability to handoff to other access points. Lack of coordination between access points will limit location techniques to single-station techniques such as POA and TOA (round-trip-delay).

IEEE 802.11—WiFi

WiFi is standardized as IEEE 802.11. Variants currently include 802.11a, 802.11b, 802.11g, and 802.11n. Designed as a short range, wireless local-arenetwork using unlicensed spectrum, WiFi system are well suited for the various proximity location techniques. Power is limited to comply with FCC Part 15 (Title 47 of the Code of Federal Regulations transmission rules, Part 15, subsection 245).

Part 15.245 of the FCC rules describes the maximum effective isotropic radiated power (EIRP) that a license-free system can emit and be certified. This rule is meant for those who intend to submit a system for certification under this part. It states that a certified system can have a maximum of 1 watt (+36 dBm) of transmit power into an omni-directional antenna that has 6 dBi gain. This results in an EIRP of: +30 dBm +6 dBi =+36 dBm (4 watts). If a higher gain omni-directional antenna is being certified, then the transmit power into that antenna must reduced so that the EIRP of that system does not exceed +36 dBm EIRP. Thus, for a 12 dBi omni antenna, the maximum certifiable power is +24 dBm (250 mW (+24 dBm+12 dBi =36 dBm). For directional antennas used on point-to-point systems, the EIRP can increase by 1 dB for every 3 dB increase in gain of the antenna. For a 24 dBi dish antenna, it works out that +24 dBm of transmit power can be fed into this high gain antenna. This results in an EIRP of: +24 dBm +24 dBi=48 dBm (64 Watts).

IEEE 802.11 proximity location methods can be either network-based or device-based.

HiperLAN

HiperLAN is short for High Performance Radio Local Area Networks. Developed by the European Telecommunications Standards Institute (ETSI), HiperLAN is a set of WLAN communication standards used chiefly in European countries.

HiperLAN is a comparatively short-range variant of a broadband radio access network and was designed to be a complementary access mechanism for public UMTS (3GPP cellular) networks and for private use as a wireless LAN type systems. HiperLAN offers high speed (up to 54 Mb/s) wireless access to a variety of digital packet networks.

IEEE 802.16—WiMAN, WiMAX

IEEE 802.16 is working group number 16 of IEEE 802, specializing in point-to-multipoint broadband wireless access.

IEEE 802.15.4—ZigBee

IEEE 802.15.4/ZigBee is intended as a specification for low-powered networks for such uses as wireless monitoring and control of lights, security alarms, motion sensors, thermostats and smoke detectors. 802.15.4/ZigBee is built on the IEEE 802.15.4 standard that specifies the MAC and PHY layers. The “ZigBee” comes from higher-layer enhancements in development by a multi-vendor consortium called the Zigbee Alliance. For example, 802.15.4 specifies 128-bit AES encryption, while ZigBee specifies but how to handle encryption key exchange. 802.15.4/ZigBee networks are slated to run in the unlicensed frequencies, including the 2.4-GHz band in the U.S.

Ultra Wideband (UWB)

Part 15.503 of FCC rules provides definitions and limitations for UWB operation. Ultrawideband is a modern embodiment of the oldest technique for modulating a radio signal (the Marconi Spark-Gap Transmitter). Pulse code modulation is used to encode data on a wide-band spread spectrum signal.

Ultra Wideband systems transmit signals across a much wider frequency than conventional radio communications systems and are usually very difficult to detect. The amount of spectrum occupied by a UWB signal, i.e., the bandwidth of the UWB signal, is at least 25% of the center frequency. Thus, a UWB signal centered at 2 GHz would have a minimum bandwidth of 500 MHz and the minimum bandwidth of a UWB signal centered at 4 GHz would be 1 GHz. The most common technique for generating a UWB signal is to transmit pulses with durations less than 1 nanosecond.

Using a very wideband signal to transmit binary information, the UWB technique is useful for a location either be proximity (via POA), AoA, TDOA or hybrids of these techniques. Theoretically, the accuracy of the TDOA estimation is limited by several practical factors such as integration time, signal-to-noise ratio (SNR) at each receive site, as well as the bandwidth of the transmitted signal. The Cramer-Rao bound illustrates this dependence. It can be approximated as:

$${TDOA}_{rms} = \frac{1}{2 π {f}_{rms} \sqrt{2 SbT}}$$

where fᵣₘₛ is the rms bandwidth of the signal, b is the noise equivalent bandwidth of the receiver, T is the integration time and S is the smaller SNR of the two sites. The TDOA equation represents a lower bound. In practice, the system should deal with interference and multipath, both of which tend to limit the effective SNR. UWB radio technology is highly immune to the effects of multipath interference since the signal bandwidth of a UWB signal is similar to the coherence bandwidth of the multipath channel allowing the different multipath components to be resolved by the receiver.

A possible proxy for power of arrival in UWB is use of the signal bit rate. Since signal-to-noise ratios (SNRs) fall with increasing power, after a certain point faster than the power rating increases, a falling s/n ratio means, in effect, greater informational entropy and a move away from the Shannon capacity, and hence less throughput. Since the power of the UWB signal decreases with range (from attenuation of radio waves by the atmosphere and the combined effects of free space loss, plane earth loss, and diffraction losses), the maximum possible bit rate will fall with increasing range. While of limited usage for a range estimate, the bit rate (or bit error rate) could serve as an indication of the approach or departure of the wireless device.

In simplest terms, as the distance between transmitter and receiver increases, the radiated radio energy is modeled as if spread over the surface of a sphere. This spherical model means that the radio power at the receiver is decreased by the square of the distance. This simple model can be refined by use of more sophisticated propagation models and use of calibration via test transmissions at likely transmission sites.

Bluetooth

Bluetooth was originally conceived as a Wireless Personal Area Network (W-PAN or just PAN). The term PAN is used interchangeably with the official term “Bluetooth Piconet”. Bluetooth was designed for very low transmission power and has a usable range of under 10 meters without specialized, directional antenna. High-powered Bluetooth devices or use of specialized directional antenna can enable ranges up to 100 meters. Considering the design philosophies (the PAN and/or cable replacement) behind Bluetooth, even the 10 m range is adequate for the original purposes behind Bluetooth. A future version of the Bluetooth specification may allow longer ranges in competition with the IEEE802.11 WiFi WLAN networks.

Use of Bluetooth for location purposes is limited to proximity (when the location of the Bluetooth master station is known) although single station Angle-of-Arrival location or AoA hybrids are possible when directional antenna are used to increase range or capacity.

Speed and direction of travel estimation can be obtained when the slave device moves between piconets. Bluetooth piconets are designed to be dynamic and constantly changing so a device moving out of range of one master and into the range of another can establish a new link in a short period of time (typically between 1-5 seconds). As the slave device moves between at least two masters, a directional vector may be developed from the known positions of the masters. If links between three or more masters are created (in series), an estimate of the direction and speed of the device can be calculated.

A Bluetooth network can provide the data link necessary for the present invention. The LDP device 110 to LES 220 data could also be established over a W-LAN or cellular data network.

RFID

Radio Frequency Identification (RFID) is an automatic identification and proximity location method, relying on storing and remotely retrieving data using devices called RFID tags or transponders. An RFID tag is an encapsulated radio transmitter or transceiver. RFID tags contain antennas to enable them to receive and respond to radio-frequency queries from an RFID Reader (a radio transceiver) and then respond with a radio-frequency response that includes the contents of the tags solid state memory.

Passive RFID tags require no internal power source and use power supplied by inductively coupling the reader with the coil antenna in the tag or by backscatter coupling between the reader and the dipole antenna of the tag. Active RFID tags require a power source.

RFID wireless location is based on the Power-of-Arrival method since the tag transmits a signal of interest only when in proximity with the RFID Reader. Since the tag is only active when scanned by a reader, the known location of the reader determines the location of the tagged item. RFID can be used to enable location-based services based on proximity (location and time of location). RFID yields no ancillary speed or direction of travel information.

The RFID reader, even if equipped with sufficient wired or wireless backhaul is unlikely to provide sufficient data link bandwidth necessary for the present invention. In a more likely implementation, the RFID reader would provide a location indication while the LDP-to-LES 220 data connection could also be established over a WLAN or cellular data network.

Near Field Communications

A variant of the passive RFID system, Near Field Communications (NFC) operates in the 13.56 MHz RFID frequency range. Proximity location is enabled, with the range of the NFC transmitter less than 8 inches. The NFC technology is standardized in ISO 18092, ISO 21481, ECMA (340, 352 and 356), and ETSI TS 102 190.

### G. Quality of Service Indicator

1. Overview and Examples

A location-enabling hardware and/or software assembly, such as the Location Device Platform (LDP), can be used to add location functionality and a communications path to any device or article. A Quality of Service Indicator (QoSI) of the kind described herein may be employed to address user expectations for location-based services. By defining and displaying a QoSI to the location-based services user, a sense of the location quality and the usefulness of a location-based service can be obtained before the service is actually invoked. This QoSI can be displayed anywhere a location-based service can be activated: at the mobile device, at a monitoring network terminal, at another monitoring mobile device, etc. The QoSI can also be delivered to the LBS application, informing the application of the pre-determined quality of service necessary. The QoSI preferably relates to the predicted accuracy but can include other quality of service parameters and implicitly includes factors such as availability.

The calculated QoSI may be overridden and a lower QoSI may be offered as a way of limiting the transaction load on highly utilized location systems or location system components. The LES also has the ability to choose between available location technologies to optimize loading, especially if the same maximum quality of service is available from multiple location systems or components.

The QoSI can be used to select among LBS applications, defining menus for the user to include only the location applications available at the calculated QoSI. Alternately, the QoSI can be used to set user expectations for the location-based services application selected.

When delivered to the LBS application in the service request, the QoSI allows for responses to be pre-formatted, based on the QoSI. This pre-assignment of application output is useful in easing contractually negotiated terms, simplifying the application's decision logic, and allows faster performance. The QoSI may be used by the location application to help ensure an outcome in-line with customer expectations for the requested service.

The QoSI can also be used to indicate the availability of LBS services while roaming since the LES can communicate with location systems in multiple operator networks.

At a high level, any location technology's predicted QoSI for accuracy can be expressed in a variety of ways. For example, the QoSI may be expressed as a function of:

availability,

predicted accuracy,

predicted precision,

predicted yield,

predicted or typical latency, and/or the consistency expected from each available location technology.

Since the accuracy of the location estimate in question is generally not known prior to a location request, and since the precision of the location system or technique is rarely uniform, proxy calculations can be used. Of course, if a series of multiple location estimates are completed from the same location in a short space of time, the QoSI can be directly determined but at a greater cost in location resources. The proxy calculations for accuracy and precision may be based on a variety of measurable factors, including: radio signal bandwidth, radio signal strength, packet delay, packet losses, variability, throughput, jitter or selective availability, and perceived noise level. Some of these measurements are unique to the radio signal used for location and may vary based on radio technology and can be different for terrestrial or satellite-based wireless location systems.

It is quite possible to use the output of one location technique to help predict the QoSI for multiple techniques. For instance, the cell-ID, cell-ID and sector, or a combination of cell-ID, sector and power-difference-of-arrival (PDOA) can be used to localize the LDP device and then the network capabilities, LDP device capabilities, network topology, radio propagation maps, calibration data, time-of-day, and historical QoSI information can be used to find if other location technologies with good accuracies are available and what the predicted QoSI could be.

The Cramer-Rao Lower Bound Estimation of Precision

One example of the mathematics behind the QoSI estimation is the Cramer-Rao Lower Bound (CRLB). The Cramer-Rao Lower Bound represents the minimum achievable variation in TDOA measurement. This, along with GDOP (geometric dilution of precision), directly relates to the maximally achievable location precision. The Cramer-Rao Lower Bound proves equally useful for receiver-based TDOA location systems (where multiple receivers locate on the same radio transmission) and in transmitter or beacon-based TDOA systems (where multiple transmitters and radio transmissions are used by a single receiver to generate a location).

Theoretically, the precision of a TDOA technology is limited by several practical factors such as integration time, signal-to-noise ratio (SNR) at the receive site, as well as the bandwidth of the transmitted signal. The Cramer-Rao bound illustrates this dependence. It can be approximated as:

$${TDOA}_{C R L B} = \frac{1}{{( 1.5 )}^{1 / 2} π {B}^{3 / 2} {T}^{1 / 2} S N {R}^{1 / 2}}$$

where B is the bandwidth of the signal, T is the integration time and SNR is the smaller SNR of the two sites. The TDOA_{CRLB} equation represents a lower bound. In practice, the actual TDOA estimate will be impacted by interference and multipath, both of which tend to limit the effective SNR. Superresolution techniques may be used to mitigate the deleterious effects of interference and multipath.

The CRLB can also be determined for Angle-of-Arrival (AoA) location techniques. Theoretically, it is expressed as:

$$A o {A}_{C R L B} = \frac{6}{{m}^{3} ( T ) S N R}$$

where m is a quantity proportional to the size of the AoA array in wavelengths, T is the integration time and SNR is the signal-to-noise ratio.

Geometric Dilution of Precision

For both receiver-based location systems and transmitter-based TDOA and AoA-based location systems, the geometry of the receiving site(s) with respect to the transmitter(s) location also influences the accuracy of the location estimate. A relationship exists between the location error, measurement error and geometry. The effect of the geometry is represented by a scalar quantity that acts to magnify the measurement error or dilute the precision of the computed result. This quantity is referred to as the Horizontal Dilution of Precision (HDOP) and is the ratio of the rms position error to the rms measurement error σ. Mathematically, it can be written as (see Leick, A., “GPS Satellite Surveying,” John Wiley & Son, 1995, p. 253):

$$H D O P = \sqrt{\frac{{σ}_{n}^{2} + {σ}_{e}^{2}}{{σ}^{2}}}$$

In this equation, σₙ² and σₑ² represent the variances of the horizontal components from the covariance matrix of the measurements. Physically, the best HDOP is realized when the intersection of the hyperbolas is orthogonal. An ideal situation in TDOA geolocation arises when the emitter is at the center of a circle and all of the receiving sites are uniformly distributed about the circumference of the circle.

Preferably, the LES will contain information on the receiver and transmitter layout for the radio network, and so the Geometric Dilution can be predicted over a coverage map, giving a GDOP estimate applicable to the QoSI calculation. This GDOP map when combined with the signal propagation map gives a very basic, low-accuracy signal-strength location functionality to the LES. Calibration, via test transmissions, of both the GDOP and signal strengths can add to the accuracy of a power-of arrival or power-difference of arrival location capability. The system can be somewhat self-calibrating as the QoSI calculated can be compared to the actual location estimation produced.

As a historical map of the calculated QoSI and the actual location estimate correlation is developed by the LES, this model can be used in the computation of future QoSI's for the same area.

The QoSI may be developed periodically or continuously based on the available information and presence of the communications path between the LES and LDP device. If the LDP device can self-locate, a periodic QoSI calculation may be performed to update the QoSI while the device is idle to preserve battery life. During a communications session, the QoSI maybe delivered from the LES server or updated from on-board resources. If a periodic measurement is available (such as received-signal-strength, bit error rate, an active (soft-handoff) list, or a network measurement request), the LES may continually re-compute the QoS during the communications session, updating the QoSI either periodically or at the end of the session.

The QoSI determination can be carried out in the LDP device using network and/or satellite signal information gathered by the LDP device. Certain information, such as the available network-based location technologies, may be either delivered by the LES over a dedicated radio link or the radio network's broadcast facilities.

The following table shows a QoSI determination based on available location technologies and the potential accuracy with each. The granularity or levels of QoSI determine the number of columns while the number of potential location technologies or techniques determines the number of rows.

QoSI Determination Table

| | Highest | 2nd Best | X Best | Lowest |
|---|---|---|---|---|
| Location | Potential | Potential | Potential | Potential |
| Technology | Accuracy | Accuracy | Accuracy | Accuracy |
| Tech 1 | X | | | |
| Tech 2 | X | X | X | |
| Tech 3 | | X | X | X |
| Tech 4 | | | X | X |
| Tech 5 | | | | X |

The LDP device may determine the technology selections from onboard resources, the radio network broadcast information, and/or the information provided by the LES. The QoSI can then be calculated by determining which technology or technique with the highest potential accuracy is available.

LBS applications with specified quality-of-service requirements may preclude the use of certain location technologies or lower the predictive QoSI for the available location technologies. For instance, a 5 second delay tolerance may preclude use of A-GPS and ECID and could lower the estimated accuracy of an U-TDOA system. To better inform the LBS user, the QoSI can be calculated (or re-calculated), delivered and displayed once a particular LBS application is selected and the precluded technologies have been removed from the QoSI calculation function.

A default, favorite or highest priority LBS application can be pre-set so that the nominal QoSI displayed by the device refers to that application or the QoSI can simply be used to indicate the best predicted accuracy available without regards to other quality of service parameters.

Once estimated, determined or otherwise measured and derived, the QoSI can be encoded as a subjective number or level within a pre-described range, a binary go/no-go indication, a static default based on the best location technology available, a value corresponding to a table of selections' or a value representing an encompassing geographic area.

Example: GSM Location QoSI

The current GSM system standards allow for multiple location techniques, both network-based and mobile-based, in the same GSM network. The QoSI determination for GSM will find the highest accuracy location system available and deliver the appropriate QoSI.

It should be noted that the QoSI determination may allow for cases where the location precision for any cell or sector is pre-set due to in-building only coverage or use of microcells (e.g., defined as cells with radii under 554 meters) or picocells (e.g., defined as cells with radii under 100 meters). Since both micro and pico-cells have effectively zero timing advance, the CGI+TA technique yields the same result as CGI alone.

The table below shows an example QoSI matrix for a GSM system. The columns headings have been arbitrarily set to scale in meters of location error, but could be set to other values including nearest intersection, city block, neighborhood, or zip code. This example assumes that the LDP device and network are fully deployed with A-GPS and U-TDOA but not AoA or H-GPS/H-TDOA. The LES radio network model shows that the serving cell is an omni-directional outdoor macro-cell with a coverage radius just over 5 km. The collected GSM Network Measurement Report (or the LDP device's internal determination) shows only two neighbor cells and so a PDOA ECID location cannot be performed. The SNR and bit-error-rate of the radio communications path is acceptable (above threshold). Finally, this table assumes that a high-accuracy location can be dithered to generate a larger location error if the QoS so demands.

QoSI Determination Table for an illustrative GSM Network

| | QoSI= | | | | | |
|---|---|---|---|---|---|---|
| | 1 | 2 | 3 | 4 | 5 | 6 |
| Location | <50 | <100 | <300 | <1000 | <5000 | >5000 |
| Technology | meters | meters | meters | meters | meters | meters |
| H-GPS | — | — | — | — | — | — |
| A-GPS | X | X | X | X | X | X |
| U-TDOA/AoA | — | — | — | — | | — |
| U-TDOA | X | X | X | X | X | X |
| CGI + TA + | — | — | X | X | X | X |
| NMR | | | | | | |
| CGI + TA | | | | | X | X |
| CGI | | | | | | X |

The LES makes the QoSI determination from the available location technologies, the on-board capabilities of the LDP device, recent historical location estimation information from other LDPs in the same area, the internal satellite model. In this example, the LES has a high confidence of a <50 meter accuracy and reports a QoSI of “1” to the LDP device and/or monitoring terminal.

Example: Unsynchronized Beacon Network QoSI

This example of the QoSI determination is based on a beacon system based on a network of unsynchronized transmitters. Radio coverage is highly variable but generally beacons are emplaced under 30 meters apart. The location of each transmitter is known to the LES. Power levels are adjusted to provide maximum coverage with minimal overlap. Due to the characteristics and intended design of the radio network, the QoSI determination matrix for this network could resemble the following table. Again, the QoSI correlation to meters-of-accuracy-error is arbitrary.

QoSI Determination Table for an illustrative
indoor beacon network

| | QoSI= | | | | |
|---|---|---|---|---|---|
| | 1 | 2 | 3 | 4 | 5 |
| Location | <1 | <10 | <30 | <100 | >100 |
| Technology | meters | meters | meters | meters | meters |
| TDOA | — | — | — | — | — |
| TOA | — | — | — | — | — |
| PDOA | — | X | X | X | X |
| POA | — | — | — | X | X |

Example: Synchronized Beacon Network QoSI

This example of the QoSI determination is based on a beacon system based on a network of tightly synchronized transmitters. Radio coverage is highly variable but generally beacons are emplaced under 30 meters apart. The location of each transmitter is known to the LES. Due to the characteristics and intended design of the radio network, the QoSI determination matrix for this network would resemble the table below. Again, the QoSI correlation to meters-of-accuracy-error is arbitrary.

QoSI Determination Table for an indoor beacon network

| | QoSI= | | | | |
|---|---|---|---|---|---|
| | 1 | 2 | 3 | 4 | 5 |
| Location | <1 | <10 | <30 | <100 | >100 |
| Technology | meters | meters | meters | meters | meters |
| TDOA | — | — | — | — | — |
| TOA | | | X | X | X |
| PDOA | | X | X | X | X |
| POA | | | | X | X |

2. Further Detailed Description

Referring to FIGS. 1 and 2, the QoSI can be determined by the LDP device's internal Processing Engine (107) or by the Location Enabling Server's Processing Engine (207) based on radio measurements, broadcast information, stored maps, typographical information, radio network information, and/or orbital parameters (ephemeris and almanac data) of satellites (received, measured, or predicted).

The QoSI, if determined by the LDP device, can be immediately displayed or stored in the LDP volatile memory (108) or non-volatile memory (109). The QoS can be displayed to the LDP wielder via the display subsystem (103). The QoS display may take the form of audible, visual, or tactile indicators or a combination thereof.

The QoSI may be determined by the LES from network and/or radio information relayed through the Radio Communications Network Interface (200). The network and radio information may be sent either by the radio network. The LDP also may collect and send forward radio or network information over the LDP-to-LES communications channel previously described.

The QoS may be delivered to a user terminal (either land-based or mobile) via a wired or wireless connection from the Location Enabling Server. If the QoS is developed by the LDP device's internal Processing Engine (107), the LDP can be set to forward the QoS based on time, a pre-determined QoS threshold or a user interaction via the LDP User Inputs (104) to the Location Enabling Server via the communications channel established by the LDP transceiver (100 and 101) to the LES's Radio Communications Network Interface (200).

Once the LES calculates or receives the QoS from the LDP device, the LES may use its Administration (202), Accounting (203), Authentication (204) and Authorization (205) subsystems to verify that the QoS from the LDP may be delivered (or always must be delivered) to a client residing on the External Communications Network (211) via the Interconnection to External Communications Network Subsystem (210).

The QoS indication on the LDP and LES client can vary immensely. From a simple binary indication of Availability or Non-Availability due to lack of communications or inability to generate a location, to more detailed projections on local maps showing the probable position and indications of the probable error, and to detailed map projections showing position, position error, speed, and heading, the location QoS can be displayed in a number of ways.

The LDP QoS indication can also express the location technology used. The Joint ANSI/ETSI E9-1-1 Phase II interoperability standard Joint Standard 36 (J-STD-036) lists twenty potential possibilities for location technologies in the “PositionSource” enumerated element field. The QoS may be used to indicate which location technology, which set of location technologies, or which hybrids of location technologies are or will be available in the network or within the LDP capabilities. The QoSI could also be used to show which technology would have preference for the next location attempt.

PositionSource ::= ENUMERATED {

unknown (0),

-- Network Position Sources

networkUnspecified (1),
networkAOA (2),
networkTOA (3),
networkTDOA (4),
networkRFFingerprinting (5),
networkCellSector (6),
networkCellSectorWithTiming (7),

-- Handset Position Sources

handsetUnspecified (16),
handsetGPS (17),
handsetAGPS (18),
handsetEOTD (19),
handsetAFLT (20)

J-STD-036 “PositionSource”

The QoSI may be displayed continuously, as developed, upon request of the user, or upon notification by the LES of a change in QoS. The LDP device, if capable of calculating the QoS and of detecting a change in QoS, may be set to alert the user to the change in QoS via the audible, visual, or tactile abilities of the Display subsystem (103). Otherwise, the QoSI can be set, triggered, or reset by the LES.

3. Scenarios

Scenario 1: QoSI Used to Select from Options

In this scenario, the mobile user consults the QoSI to determine the predicted location quality of service. Seeing a low or poor QoSI, the user opts to be delivered the street address of a point-of-interest rather than a map, thus saving on bandwidth and/or services costs

Scenario 2: QoSI Used to Automatically Select Between Services

In this scenario, the mobile LBS application uses the QoSI to determine the predicted location quality of service. Seeing a low or poor QoSI, the application aborts the location query, saving on network transactions, and provides a compass display derived from the on-board magnetic compass.

Scenario 3: QoSI Used to Automatically Select Level of Detail from Pre-Determined Responses

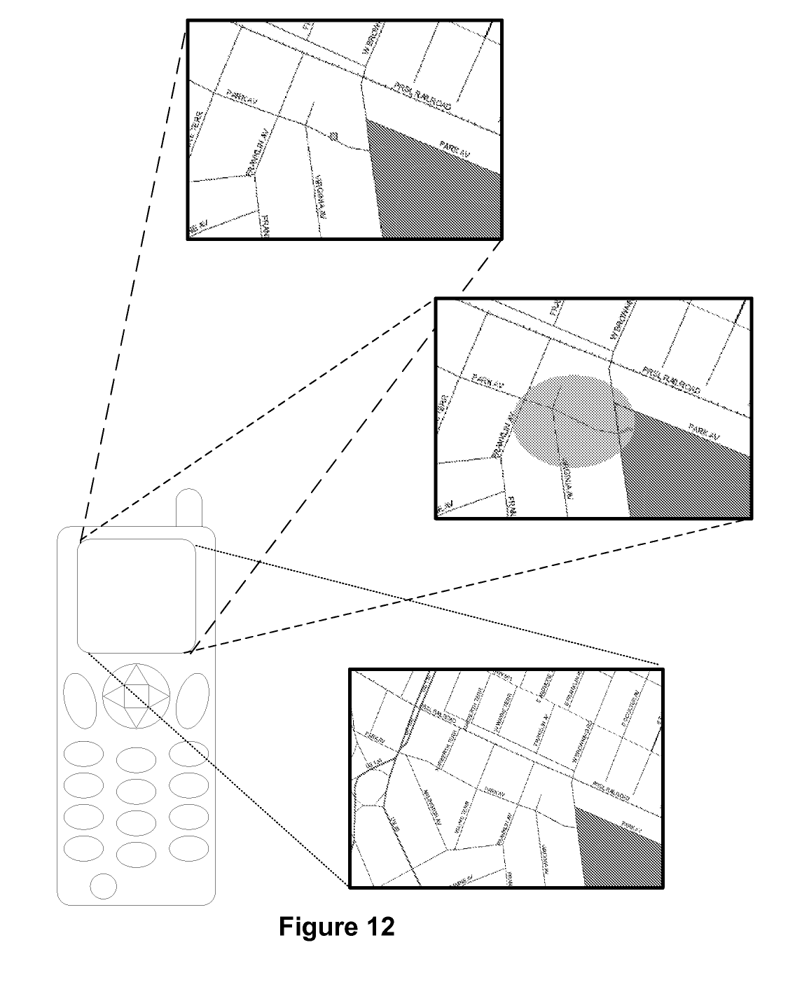

In this scenario, the networked LBS application uses the QoSI to determine the actual location quality of service level from a set of pre-negotiated levels. Based on the QoSI level and the subscriber preferences profile, the LBS application selects the map scaling to best display the area of interest. For instance, a high or “good” QoSI could result in the LBS application sending the mobile a detailed map showing the mobile's immediate area and the direction to the point of interest. A lower QoSI could result in a low detail map of the general area showing the point of interest. At the lowest level, the QoSI could simply show the street address of the POI. (See FIG. 12.)

Scenario 4: QoSI Used to Provide a Notification to User/LBS Application/Service Provider

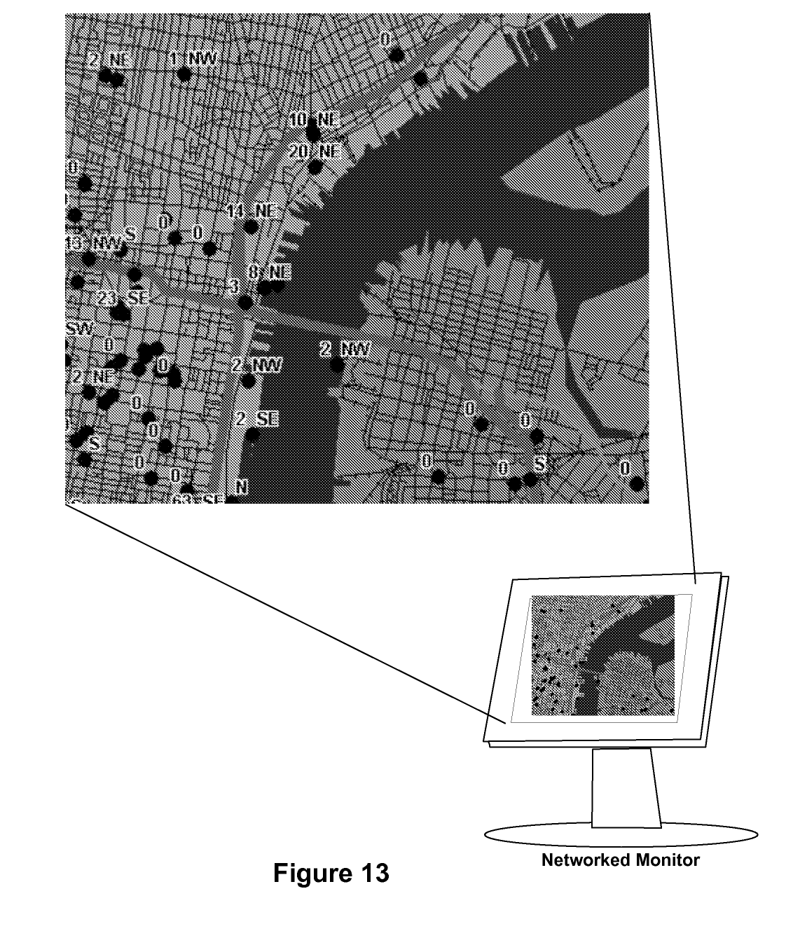

By setting a QoSI threshold, the LDP device can alarm or notify when the QoSI drops below (or stays below) a pre-set threshold. An example would be when a pet tracking application alarms when a reported (from the tracking device) QoSI falls to the point where the location of the pet inside the pre-defined geo-fenced area becomes impossible to determine or when the QoSI shows the location is completely unavailable. (See FIG. 13.)

Scenario 5: QoSI Threshold Set by Mobile User

In this scenario, an alarm threshold is set by the mobile user and the location device is set to produce a QoSI periodically or upon a change in service level (for instance when the A-GPS location technique becomes unavailable and the device defaults to only cell-sector location). This alarm alerts the user to changes in the QoSI and the lowered level of service available to any LBS applications used.

Scenario 6: QoSI Used to Enable or Disable Functions

In this scenario, the QoSI is used to enable, disable, or tailor functions. For instance, the QoSI can include a time-of-day. Using the location QoSI with the time-of-day, a mobile displayed map can not only be scaled appropriately based on the location accuracy, but the map coloring can be altered for better clarity using night-time vision.

Scenario 7: QoSI Allows Better Selection from Menu

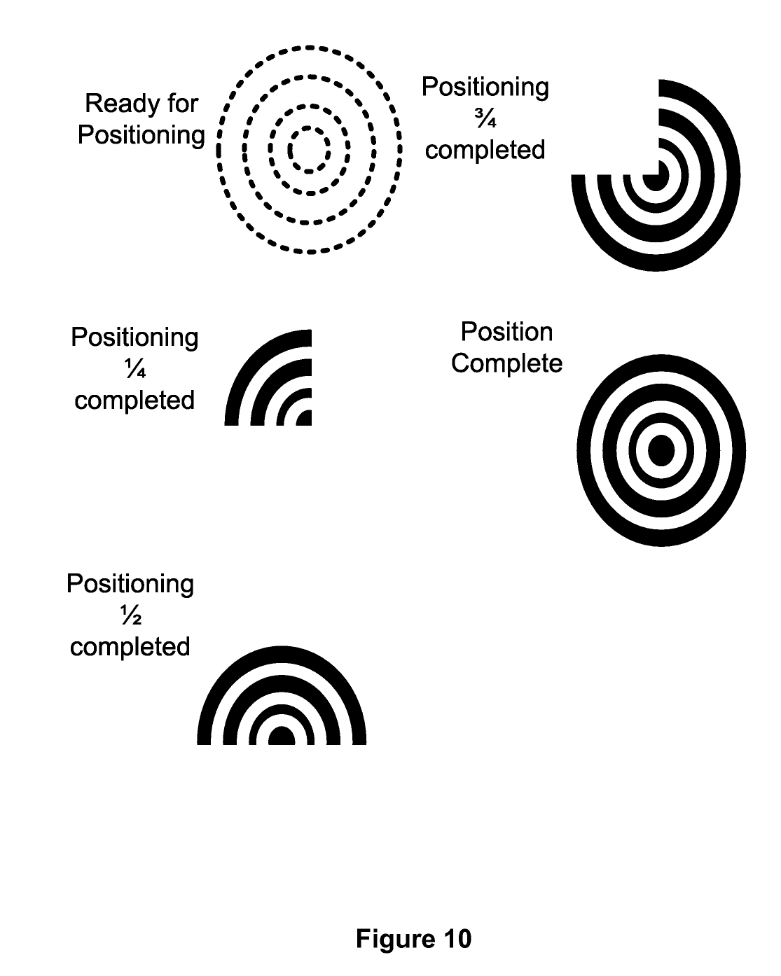

In this scenario, the mobile user consults the QoSI to determine the predicted location quality of service. The QoSI is displayed with the menu of services and includes both an accuracy and time-to-locate indicator. Seeing a long delay or a low or poor QoSI, the user opts to be delivered the street address of a point-of-interest rather than a map saving on bandwidth and/or services costs. (See FIG. 10.)

4. Description with Reference to FIGS. 4A-13

We will now conclude the detailed description of the QoSI aspect of the present invention with reference to the examples shown in the appended drawings.

FIG. 4A depicts a process flowchart illustrating an exemplary use of a QoSI. As shown, in this exemplary implementation the LES is provided with gaming jurisdictional information and information provided by the wireless location system. The precise details of what information is provided to the LES will depend upon the precise details of what kinds of services the LES is to provide. The LDP device accesses the wireless communications network and requests access to gaming services, and the access request includes a QoSI. This request is routed to the gaming application server, and the gaming application server in turn requests location information from the LES 220. The LES requests the WLS to locate the LDP device, and the WLS returns the location information as well as a QoSI to the LES 220. In this example, the LES determines that the location of the LDP device cannot be confirmed to be within the approved jurisdictional area. Accordingly, the LES sends a “no-go” indication to the gaming application server, and the LDP device is notified of this and is provided with the QoSI.

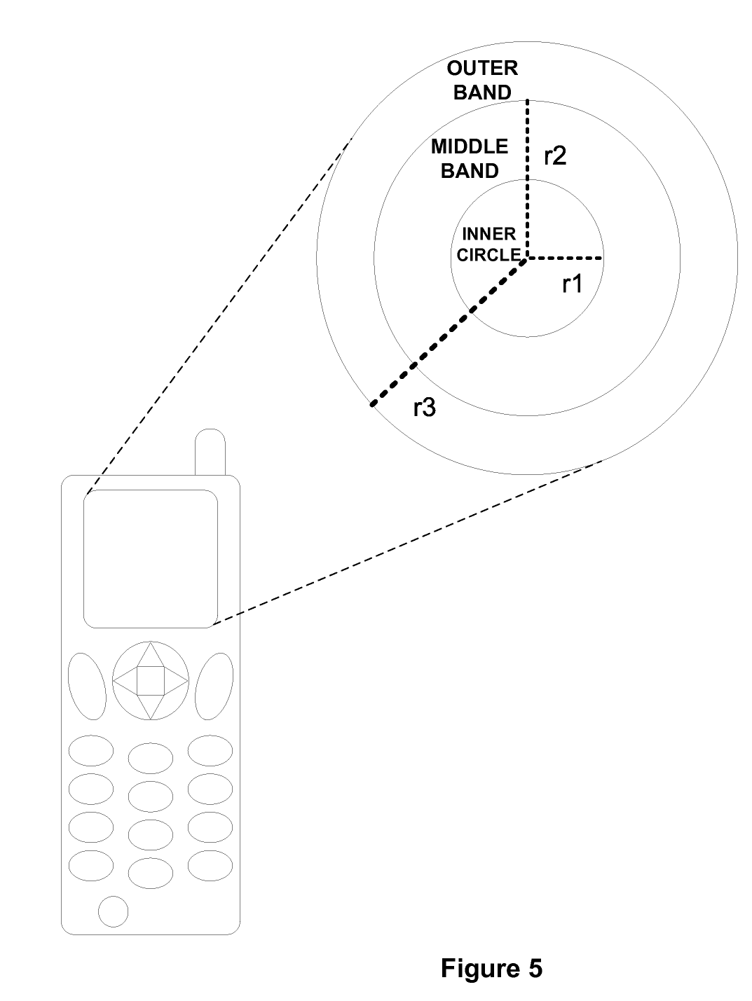

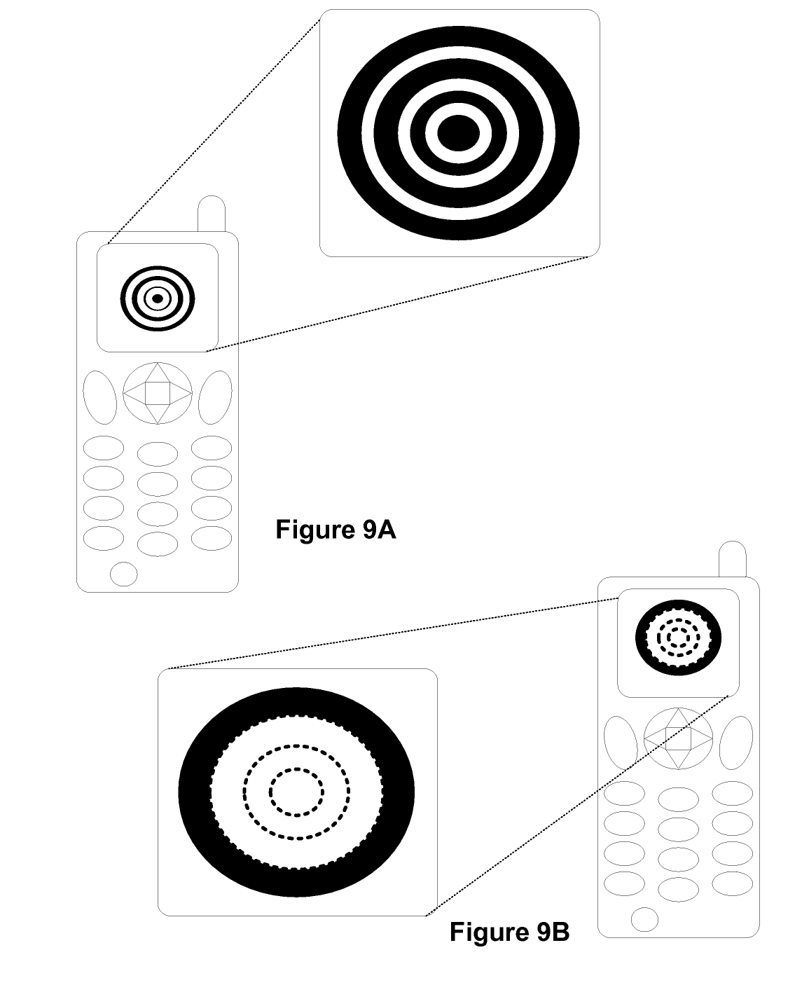

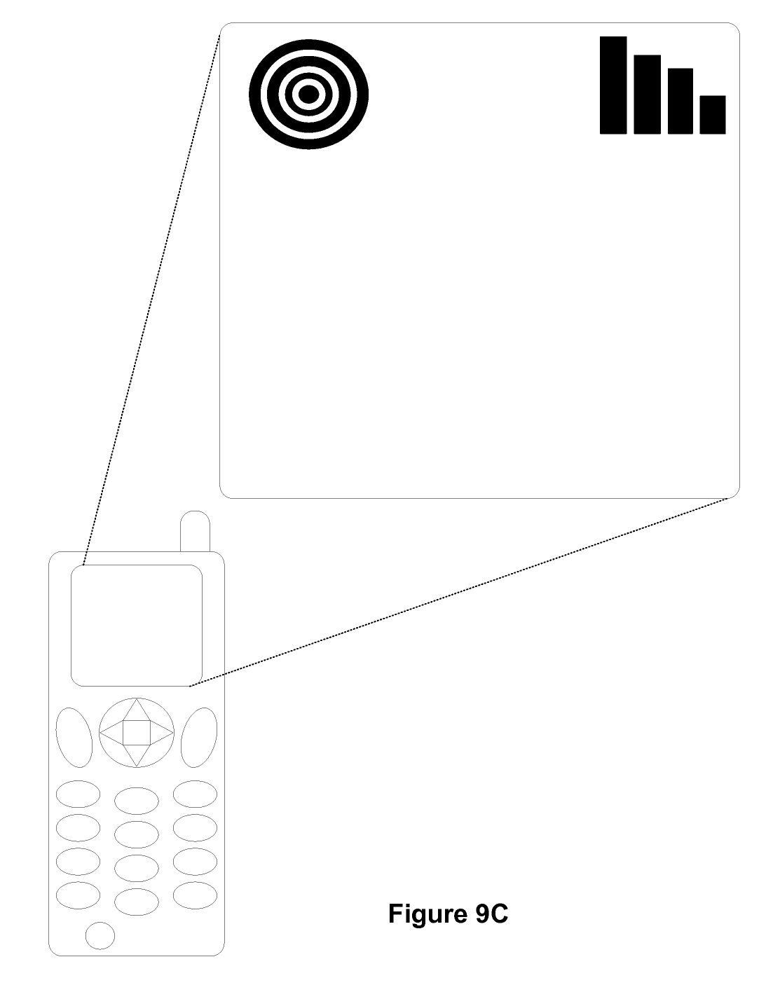

FIG. 5 depicts a “radial display” example of a QoSI. In this example, a series of concentric, circular bands are displayed. The inner-most colored band is indicative of the actual or predicted quality of a location estimate. For example, FIG. 9A shows an example of a “high quality” QoSI with the inner-most bands colored in, thus indicating better accuracy and precision. FIG. 9B shows an example of a “low quality” QoSI with only the outer-most band colored in, thus suggesting that the location estimate is less accurate/precise.

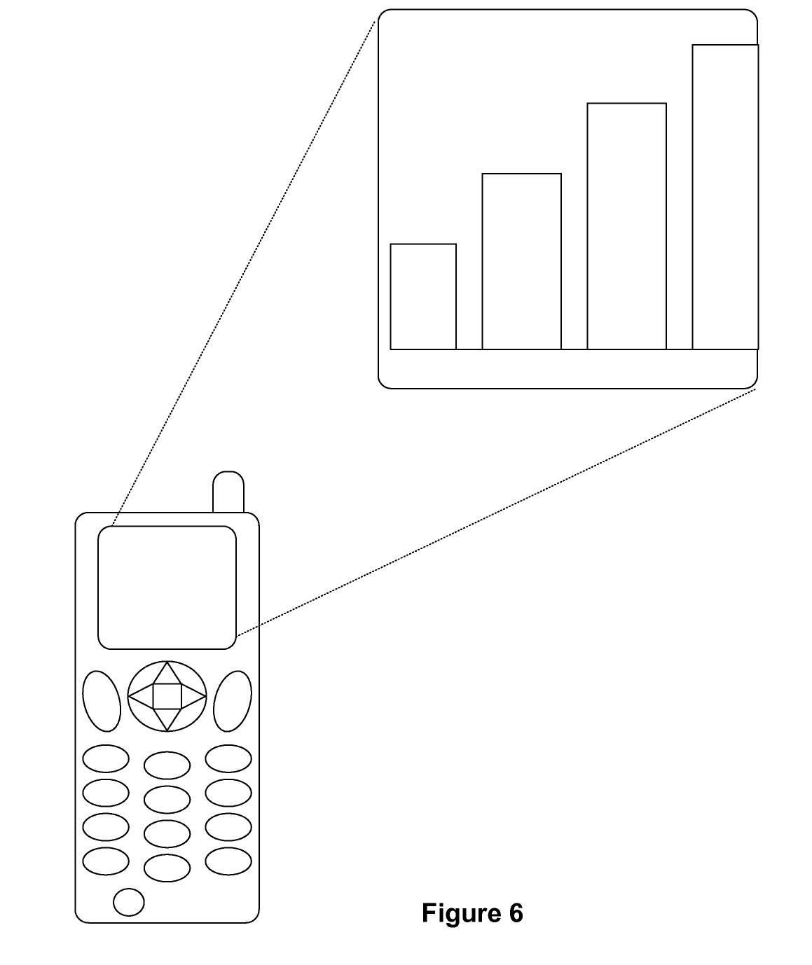

FIG. 6 depicts “four bar display” type of QoSI. This example is modeled after the familiar bar graph used to indicate signal strength in a mobile phone.

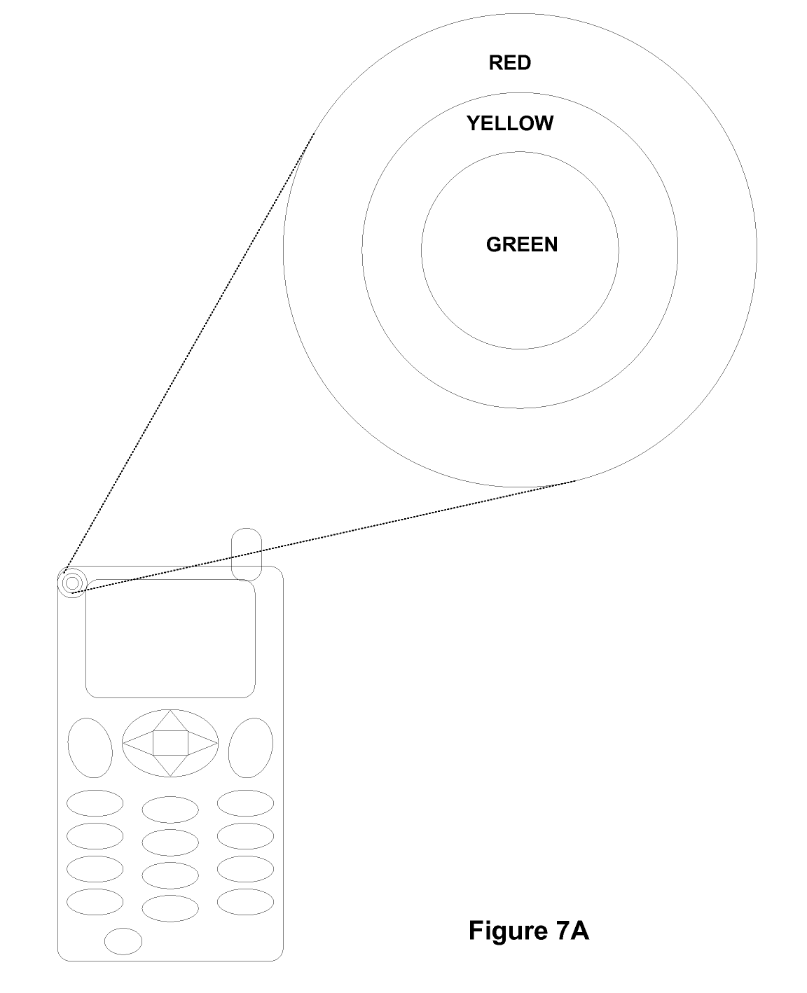

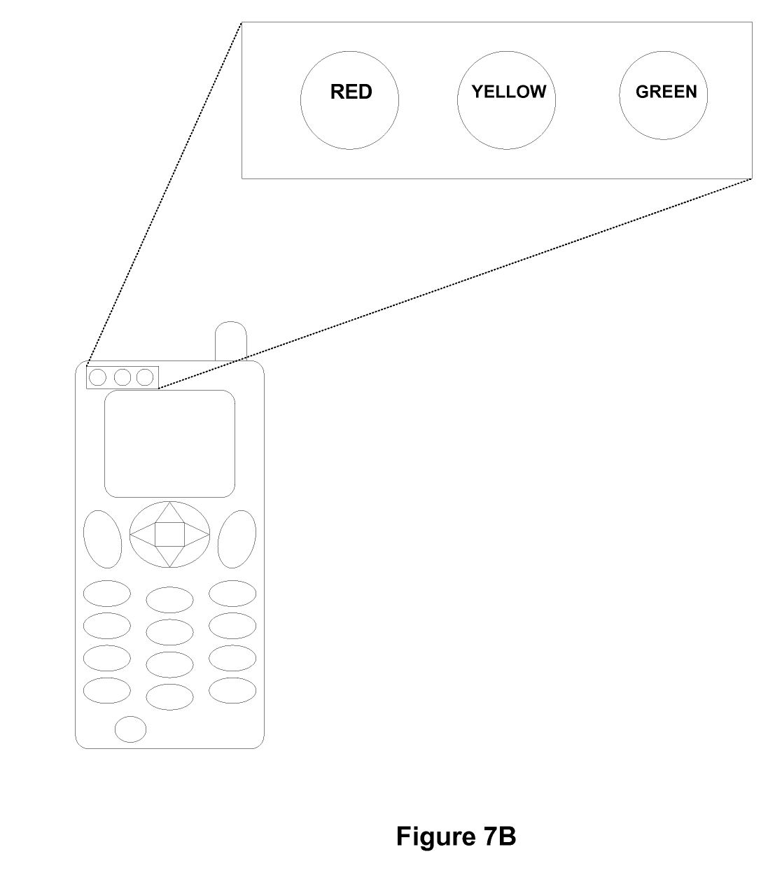

FIGS. 7A and 7B depict examples using LED displays. FIG. 7A depicts a tri-color LED display used as a QoSI, and FIG. 7B depicts a three LED tri-color display used as a QoSI. For example, in the embodiments of FIGS. 7A and 7B, a green light indicates the highest quality QoSI, a yellow light indicates the middle level of quality, and the red light indicates the lowest quality. Of course, the choice of colors is a design choice and the invention is by no means limited to these choices described here.

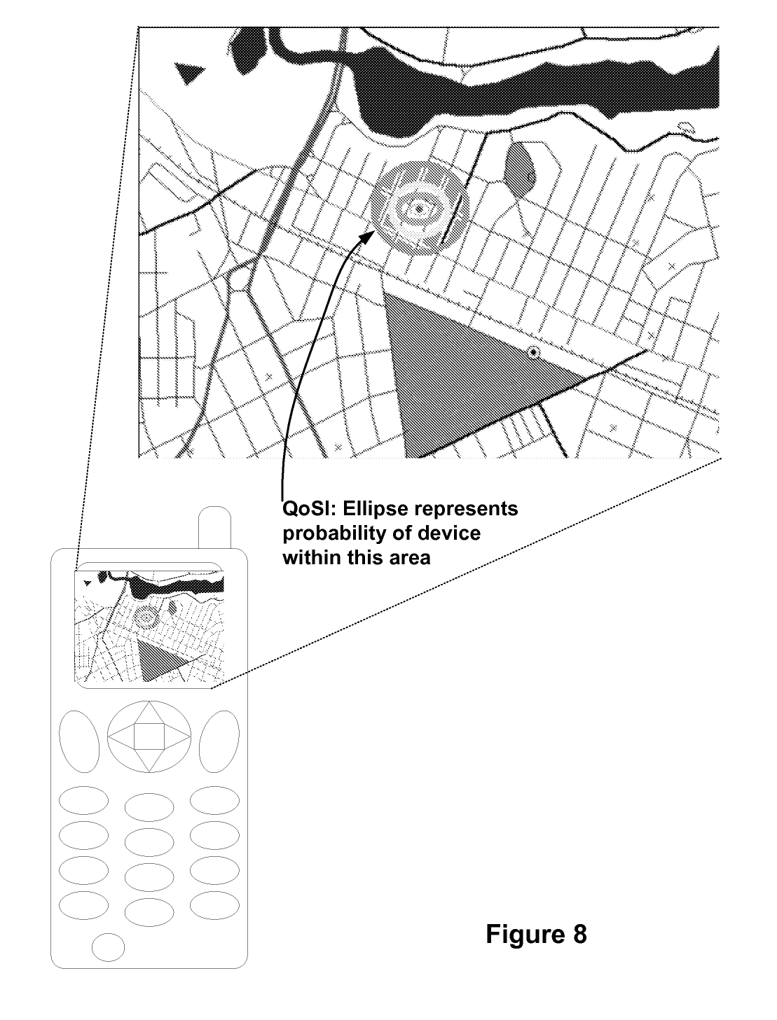

FIG. 8 depicts an example where the QoSI is located on a map display. Here, the QoSI element takes the form of a series of ellipses representing the probabilities of the mobile device being located within the area of each ellipse. Different colors may be used to represent each elliptical area.

FIGS. 9A, 9B and 9C depict examples of how a QoSI can be used to show the predicted accuracy of a selected LBS application. FIG. 9A shows an exemplary display for a high accuracy QoSI for a selected LBS application. FIG. 9B shows an example of a low accuracy QoSI for a selected LBS application. FIG. 9C shows a display including the radial/circular QoSI and a four bar signal strength display.

FIG. 10 shows an example of how a QoSI can be used to show the user of a mobile device both the location accuracy and the progress of the positioning and/or delivery of the LBS application, which in turn shows the latency aspect of the quality of service. As shown, the extent to which the position processing has been completed is reflected in, or roughly proportional to, the fraction of the QoSI that is being displayed. Thus, for example, when positioning is ¼ completed for a high accuracy location, only ¼ of the “high accuracy” QoSI is displayed.

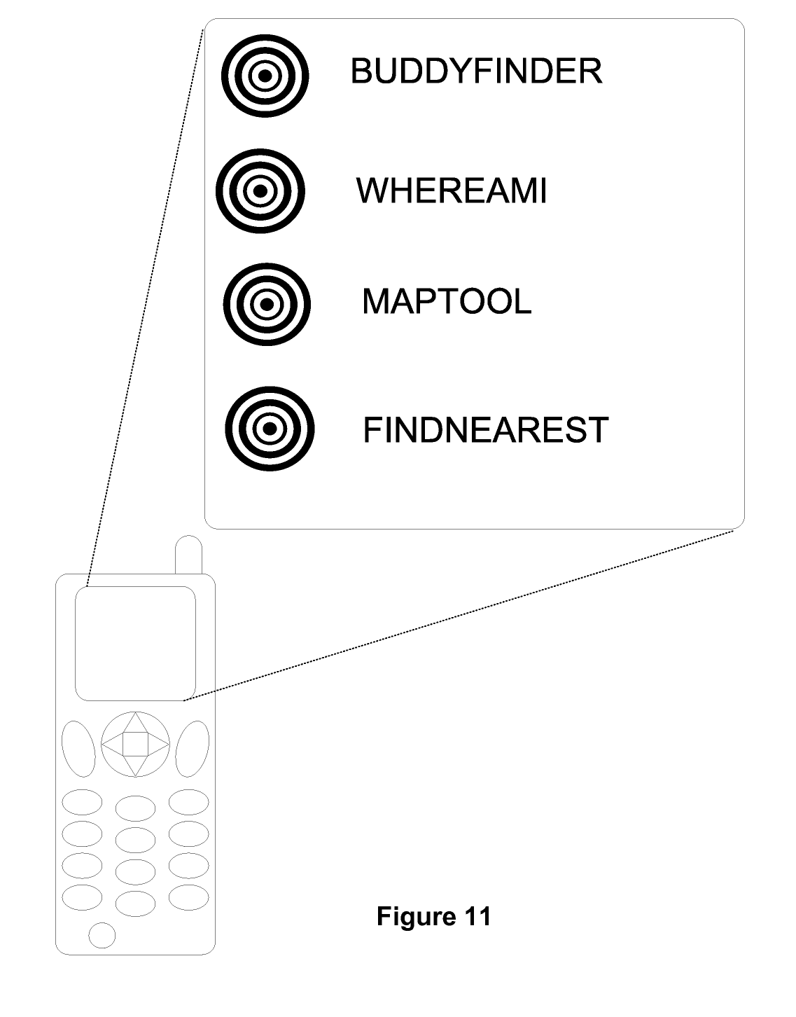

FIG. 11 depicts yet another example of a QoSI display, in this case multiple QoSI's are displayed individually for different LBS applications. In this example, we show four QoSI's, one each for a “Buddy Finder” application, “Where am I?” application, “Map Tool” application, and “Find Nearest” application.

FIG. 12 depicts still another example of a QoSI used by the location-based services application to determine the correct display option, in this case the selection between the multiple map displays to meet the user expectations created by the QoSI. In this example, the QoSI is pre-set to a 3 level indicator with a corresponding 3 levels of map details pre-set at the LBS map application. As the QoSI decreases, higher accuracy maps of the same area can be displayed, in effect, zooming into the LBS application user's location. As the figure shows, a high QoSI delivered to in this LBS application results in a point on a local map with street names, the medium QoSI an area on the same local map and the worst QoSI results in the delivery of a low-detail area map.

FIG. 13 depicts an example of a map QoSI displayed a networked monitor. This example is intended to show that a QoSI associated with a particular mobile device or arbitrary group of mobile devices may be displayed on an external monitor, e.g., a monitor used by an E-911 PSAP or fleet management dispatcher, etc. In this figure, the location estimate is displayed as a circle while the QoSI is displayed as the color of the circle. The circles are sized as to not obscure the underlying map details.

### H. Citations to WLS-Related Patents

TruePosition, Inc., the assignee of the present invention, and its wholly owned subsidiary, KSI, Inc., have been inventing in the field of wireless location for many years, and have procured a portfolio of related patents, some of which are cited above. Therefore, the following patents may be consulted for further information and background concerning inventions and improvements in the field of wireless location:
1. U.S. Pat. No. 6,876,859 B2, Apr. 5, 2005, Method for Estimating TDOA and FDOA in a Wireless Location System;
2. U.S. Pat. No. 6,873,290 B2, Mar. 29, 2005, Multiple Pass Location Processor;
3. U.S. Pat. No. 6,782,264 B2, Aug. 24, 2004, Monitoring of Call Information in a Wireless Location System;
4. U.S. Pat. No. 6,771,625 B1, Aug. 3, 2004, Pseudolite-Augmented GPS for Locating Wireless Phones;
5. U.S. Pat. No. 6,765,531 B2, Jul. 20, 2004, System and Method for Interference Cancellation in a Location Calculation, for Use in a Wireless Locations System;
6. U.S. Pat. No. 6,661,379 B2, Dec. 9, 2003, Antenna Selection Method for a Wireless Location System;
7. U.S. Pat. No. 6,646,604 B2, Nov. 11, 2003, Automatic Synchronous Tuning of Narrowband Receivers of a Wireless System for Voice/Traffic Channel Tracking;
8. U.S. Pat. No. 6,603,428 B2, Aug. 5, 2003, Multiple Pass Location Processing;
9. U.S. Pat. No. 6,563,460 B2, May 13, 2003, Collision Recovery in a Wireless Location System;
10. U.S. Pat. No. 6,546,256 B1, Apr. 8, 2003, Robust, Efficient, Location-Related Measurement;
11. U.S. Pat. No. 6,519,465 B2, Feb. 11, 2003, Modified Transmission Method for Improving Accuracy for E-911 Calls;
12. U.S. Pat. No. 6,492,944 B1, Dec. 10, 2002, Internal Calibration Method for a Receiver System of a Wireless Location System;
13. U.S. Pat. No. 6,483,460 B2, Nov. 19, 2002, Baseline Selection Method for Use in a Wireless Location System;
14. U.S. Pat. No. 6,463,290 B1, Oct. 8, 2002, Mobile-Assisted Network Based Techniques for Improving Accuracy of Wireless Location System;
15. U.S. Pat. No. 6,400,320, Jun. 4, 2002, Antenna Selection Method For A Wireless Location System;
16. U.S. Pat. No. 6,388,618, May 14, 2002, Signal Collection on System For A Wireless Location System;
17. U.S. Pat. No. 6,366,241, Apr. 2, 2002, Enhanced Determination Of Position-Dependent Signal Characteristics;
18. U.S. Pat. No. 6,351,235, Feb. 26, 2002, Method And System For Synchronizing Receiver Systems Of A Wireless Location System;
19. U.S. Pat. No. 6,317,081, Nov. 13, 2001, Internal Calibration Method For Receiver System Of A Wireless Location System;
20. U.S. Pat. No. 6,285,321, Sep. 4, 2001, Station Based Processing Method For A Wireless Location System;
21. U.S. Pat. No. 6,334,059, Dec. 25, 2001, Modified Transmission Method For Improving Accuracy For E-911 Calls;
22. U.S. Pat. No. 6,317,604, Nov. 13, 2001, Centralized Database System For A Wireless Location System;
23. U.S. Pat. No. 6,288,676, Sep. 11, 2001, Apparatus And Method For Single Station Communications Localization;
24. U.S. Pat. No. 6,288,675, Sep. 11, 2001, Single Station Communications Localization System;
25. U.S. Pat. No. 6,281,834, Aug. 28, 2001, Calibration For Wireless Location System;
26. U.S. Pat. No. 6,266,013, Jul. 24, 2001, Architecture For A Signal Collection System Of A Wireless Location System;
27. U.S. Pat. No. 6,184,829, Feb. 6, 2001, Calibration For Wireless Location System;
28. U.S. Pat. No. 6,172,644, Jan. 9, 2001, Emergency Location Method For A Wireless Location System;
29. U.S. Pat. No. 6,115,599, Sep. 5, 2000, Directed Retry Method For Use In A Wireless Location System;
30. U.S. Pat. No. 6,097,336, Aug. 1, 2000, Method For Improving The Accuracy Of A Wireless Location System;
31. U.S. Pat. No. 6,091,362, Jul. 18, 2000, Bandwidth Synthesis For Wireless Location System;
32. U.S. Pat. No. 6,047,192, Apr. 4, 2000, Robust, Efficient, Localization System;
33. U.S. Pat. No. 6,108,555, Aug. 22, 2000, Enhanced Time Difference Localization System;
34. U.S. Pat. No. 6,101,178, Aug. 8, 2000, Pseudolite-Augmented GPS For Locating Wireless Telephones;
35. U.S. Pat. No. 6,119,013, Sep. 12, 2000, Enhanced Time-Difference Localization System;
36. U.S. Pat. No. 6,127,975, Oct. 3, 2000, Single Station Communications Localization System;
37. U.S. Pat. No. 5,959,580, Sep. 28, 1999, Communications Localization System;
38. U.S. Pat. No. 5,608,410, Mar. 4, 1997, System For Locating A Source Of Bursty Transmissions;
39. U.S. Pat. No. 5,327,144, Jul. 5, 1994, Cellular Telephone Location System; and
40. U.S. Pat. No. 4,728,959, Mar. 1, 1988, Direction Finding Localization System.

### H. Conclusion

The true scope the present invention is not limited to the illustrative embodiments disclosed herein. For example, the foregoing disclosure of a Wireless Location System (WLS) uses explanatory terms, such as wireless device, mobile station, client, network station, and the like, which should not be construed so as to limit the scope of protection of this application, or to otherwise imply that the inventive aspects of the WLS are limited to the particular methods and apparatus disclosed. For example, the terms LDP device and LES are not intended to imply that the specific exemplary structures depicted in FIGS. 1 and 2 must be used in practicing the present invention. A specific embodiment of the present invention may utilize any type of mobile wireless device as well as any type of server computer that may be programmed to carry out the invention as described herein. Moreover, in many cases the place of implementation (i.e., the functional element) described herein is merely a designer's preference and not a requirement. Accordingly, except as they may be expressly so limited, the scope of protection is not intended to be limited to the specific embodiments described above.

We claim:

1. A mobile wireless device configured to provide a location quality of service indicator (QoSI).

2. A mobile wireless device as recited in claim 1, comprising:
a wireless communications subsystem;
a processor operatively coupled to said wireless communications subsystem;
a computer readable storage medium operatively coupled to said processor; and
a display operatively coupled to said processor.

3. A mobile wireless device as recited in claim 2, wherein said QoSI is indicative of the quality of a calculated location estimation for use by a location-based service.

4. A mobile wireless device as recited in claim 3, wherein said device is configured to display said QoSI before the location-based service is invoked.

5. A mobile wireless device as recited in claim 3, wherein said QoSI is indicative of the quality of a calculated location estimation for another device.

6. A mobile wireless device as recited in claim 3, wherein said QoSI is representative of predicted location accuracy.

7. A mobile wireless device as recited in claim 3, wherein said QoSI is representative of predicted location availability.

8. A mobile wireless device as recited in claim 3, wherein said QoSI is representative of predicted location latency.

9. A mobile wireless device as recited in claim 3, wherein said QoSI is representative of predicted location precision.

10. A mobile wireless device as recited in claim 3, wherein said QoSI is representative of predicted location yield.

11. A mobile wireless device as recited in claim 3, wherein said QoSI is visible.

12. A mobile wireless device as recited in claim 3, wherein said QoSI is audible.

13. A mobile wireless device as recited in claim 3, wherein said QoSI is tactile.

14. A mobile wireless device as recited in claim 3, wherein said QoSI is based, at least in part, upon a Cramer-Rao Lower Bound computation.

15. A mobile wireless device as recited in claim 3, wherein said QoSI is based, at least in part, upon a Geometric Dilution of Precision (GDOP) computation.

16. A mobile wireless device as recited in claim 3, wherein said QoSI is based, at least in part, upon a set of location technologies available for use in collecting data to be used in calculating said location estimation.

17. A mobile wireless device as recited in claim 3, wherein said device is configured to communicate said QoSI to a server.

18. A mobile wireless device as recited in claim 17, wherein said device is configured to communicate said QoSI to a location enabling server (LES).

19. A mobile wireless device as recited in claim 3, wherein said device is configured to communicate said QoSI to another mobile wireless device.

20. A mobile wireless device as recited in claim 3, wherein said device is configured to permit said QoSI to be used to select among location-based services (LBS) applications.

21. A mobile wireless device as recited in claim 3, wherein said device is configured to permit said QoSI to be used to select location applications available at the calculated QoSI.

22. A mobile wireless device as recited in claim 3, wherein said device is configured to deliver said QoSI to a location application with a service request, and to receive responses which are formatted for display based on the QoSI.

23. A mobile wireless device as recited in claim 3, wherein a series of multiple location estimates are employed to determine said QoSI.

24. A mobile wireless device as recited in claim 3, wherein proxy calculations are employed to determine said QoSI.

25. A mobile wireless device as recited in claim 24, wherein said proxy calculations are related to accuracy and precision.

26. A mobile wireless device as recited in claim 25, wherein said proxy calculations are based on at least one member of the following group: radio signal bandwidth, radio signal strength, packet delay, packet losses, variability, throughput, jitter, selective availability, and perceived noise level.

27. A mobile wireless device as recited in claim 3, wherein a historical map of calculated QoSI's and related location estimates are used in the determination of QoSI's for a given area.

28. A mobile wireless device as recited in claim 3, wherein said QoSI is developed periodically.

29. A mobile wireless device as recited in claim 3, wherein said QoSI is developed continuously.

30. A mobile wireless device as recited in claim 3, wherein said QoSI is determined using received signal information and information about available network-based location technologies.

31. A mobile wireless device as recited in claim 3, wherein said QoSI has the form of a bar graph.

32. A mobile wireless device as recited in claim 3, wherein said QoSI has the form of a radial graph.

33. A mobile wireless device as recited in claim 3, wherein said QoSI has the form of a multi-colored display.

34. A mobile wireless device as recited in claim 3, wherein said QoSI has the form of a QoSI element overlaid on a map display.

35. A mobile wireless device as recited in claim 3, wherein said QoSI comprises multiple QoSI elements corresponding to multiple location services.

36. A mobile wireless device as recited in claim 3, wherein the device further comprises a GPS receiver for self-locating, and wherein a periodic QoSI calculation is performed to update the QoSI while the device is idle.

37. A mobile wireless device as recited in claim 3, wherein a QoSI associated with a first location technique is employed to predict a QoSI for a second location technique.

38. A mobile wireless device as recited in claim 3, wherein the device is adapted to operate in a GSM wireless communications system.

39. A mobile wireless device as recited in claim 3, wherein the device is adapted to operate in a UMTS wireless communications system.

40. A mobile wireless device as recited in claim 3, wherein the GSM wireless communications system allows for multiple location techniques, including network-based and mobile-based techniques, and the QoSI displayed by the device is based upon the highest accuracy location technology available.

41. A mobile wireless device as recited in claim 3, wherein said QoSI further indicates the type of location technology used to provide said location estimation.

42. A mobile wireless device as recited in claim 3, wherein the device is further configured to generate an alarm when the QoSI indicates a quality of service below a pre-set threshold.

43. A mobile wireless device as recited in claim 42, wherein the device provides a mechanism for a user to set said threshold.

44. A method for use by a mobile wireless device, comprising providing a location quality of service indicator (QoSI), wherein said QoSI is indicative of the quality of a calculated location estimation for use by a location-based service.

45. A method as recited in claim 44, wherein said device is configured to display said QoSI before the location-based service is invoked.

46. A method as recited in claim 44, wherein said QoSI is indicative of the quality of a calculated location estimation for another device.

47. A method as recited in claim 44, wherein said QoSI is representative of predicted location accuracy.

48. A method as recited in claim 44, wherein said QoSI is representative of predicted location availability.

49. A method as recited in claim 44, wherein said QoSI is representative of predicted location latency.

50. A method as recited in claim 44, wherein said QoSI is representative of predicted location precision.

51. A method as recited in claim 44, wherein said QoSI is representative of predicted location yield.

52. A method as recited in claim 44, wherein said QoSI is visible.

53. A method as recited in claim 44, wherein said QoSI is audible.

54. A method as recited in claim 44, wherein said QoSI is tactile.

55. A method as recited in claim 44, wherein said QoSI is based, at least in part, upon a Cramer-Rao Lower Bound computation.

56. A method as recited in claim 44, wherein said QoSI is based, at least in part, upon a Geometric Dilution of Precision (GDOP) computation.

57. A method as recited in claim 44, wherein said QoSI is based, at least in part, upon a set of location technologies available for use in collecting data to be used in calculating said location estimation.

58. A method as recited in claim 44, wherein said device is configured to communicate said QoSI to a server.

59. A method as recited in claim 58, wherein said device is configured to communicate said QoSI to a location enabling server (LES).

60. A method as recited in claim 44, wherein said device is configured to communicate said QoSI to another mobile wireless device.

61. A method as recited in claim 44, wherein said device is configured to permit said QoSI to be used to select among location-based services (LBS) applications.

62. A method as recited in claim 44, wherein said device is configured to permit said QoSI to be used to select location applications available at the calculated QoSI.

63. A method as recited in claim 44, wherein said device is configured to deliver said QoSI to a location application with a service request, and to receive responses which are formatted for display based on the QoSI.

64. A method as recited in claim 44, wherein a series of multiple location estimates are employed to determine said QoSI.

65. A method as recited in claim 44, wherein proxy calculations are employed to determine said QoSI.

66. A method as recited in claim 65, wherein said proxy calculations are related to accuracy and precision.

67. A method as recited in claim 66, wherein said proxy calculations are based on at least one member of the following group: radio signal bandwidth, radio signal strength, packet delay, packet losses, variability, throughput, jitter, selective availability, and perceived noise level.

68. A method as recited in claim 44, wherein a historical map of calculated QoSI's and related location estimates are used in the determination of QoSI's for a given area.

69. A method as recited in claim 44, wherein said QoSI is developed periodically.

70. A method as recited in claim 44, wherein said QoSI is developed continuously.

71. A method as recited in claim 44, wherein said QoSI is determined using received signal information and information about available network-based location technologies.

72. A method as recited in claim 44, wherein said QoSI has the form of a bar graph.

73. A method as recited in claim 44, wherein said QoSI has the form of a radial graph.

74. A method as recited in claim 44, wherein said QoSI has the form of a multi-colored display.

75. A method as recited in claim 44, wherein said QoSI has the form of a QoSI element overlaid on a map display.

76. A method as recited in claim 44, wherein said QoSI comprises multiple QoSI elements corresponding to multiple location services.

77. A method as recited in claim 44, wherein the device further comprises a GPS receiver for self-locating, and wherein a periodic QoSI calculation is performed to update the QoSI while the device is idle.

78. A method as recited in claim 44, wherein a QoSI associated with a first location technique is employed to predict a QoSI for a second location technique.

79. A method as recited in claim 44, wherein the device is adapted to operate in a GSM wireless communications system.

80. A method as recited in claim 44, wherein the device is adapted to operate in a UMTS wireless communications system.

81. A method as recited in claim 44, wherein the GSM wireless communications system allows for multiple location techniques, including network-based and mobile-based techniques, and the QoSI displayed by the device is based upon the highest accuracy location technology available.

82. A method as recited in claim 44, wherein said QoSI further indicates the type of location technology used to provide said location estimation.

83. A method as recited in claim 44, wherein the device is further configured to generate an alarm when the QoSI indicates a quality of service below a pre-set threshold.

84. A method as recited in claim 83, wherein the device provides a mechanism for a user to set said threshold.

85. A computer readable medium (CRM) comprising executable instructions for causing a mobile wireless device to perform a method, said method comprising providing a location quality of service indicator (QoSI), wherein said QoSI is indicative of the quality of a calculated location estimation for use by a location-based service.

86. A computer readable medium as recited in claim 85, wherein said method includes configuring the device to display said QoSI before the location-based service is invoked.

87. A computer readable medium as recited in claim 85, wherein said QoSI is indicative of the quality of a calculated location estimation for another device.

88. A computer readable medium as recited in claim 85, wherein said QoSI is representative of predicted location accuracy.

89. A computer readable medium as recited in claim 85, wherein said QoSI is representative of predicted location availability.

90. A computer readable medium as recited in claim 85, wherein said QoSI is representative of predicted location latency.

91. A computer readable medium as recited in claim 85, wherein said QoSI is representative of predicted location precision.

92. A computer readable medium as recited in claim 85, wherein said QoSI is representative of predicted location yield.

93. A computer readable medium as recited in claim 85, wherein said QoSI is visible.

94. A computer readable medium as recited in claim 85, wherein said QoSI is audible.

95. A computer readable medium as recited in claim 85, wherein said QoSI is tactile.

96. A computer readable medium as recited in claim 85, wherein said QoSI is based, at least in part, upon a Cramer-Rao Lower Bound computation.

97. A computer readable medium as recited in claim 85, wherein said QoSI is based, at least in part, upon a Geometric Dilution of Precision (GDOP) computation.

98. A computer readable medium as recited in claim 85, wherein said QoSI is based, at least in part, upon a set of location technologies available for use in collecting data to be used in calculating said location estimation.

99. A computer readable medium as recited in claim 85, wherein said method includes configuring the device to communicate said QoSI to a server.

100. A computer readable medium as recited in claim 99, wherein said method includes configuring the device to communicate said QoSI to a location enabling server (LES).

101. A computer readable medium as recited in claim 85, wherein said method includes configuring the device to communicate said QoSI to another mobile wireless device.

102. A computer readable medium as recited in claim 85, wherein said method includes configuring the device to permit said QoSI to be used to select among location-based services (LBS) applications.

103. A computer readable medium as recited in claim 85, wherein said method includes configuring the device to permit said QoSI to be used to select location applications available at the calculated QoSI.

104. A computer readable medium as recited in claim 85, wherein said method includes configuring the device to deliver said QoSI to a location application with a service request, and to receive responses which are formatted for display based on the QoSI.

105. A computer readable medium as recited in claim 85, wherein a series of multiple location estimates are employed to determine said QoSI.

106. A computer readable medium as recited in claim 85, wherein proxy calculations are employed to determine said QoSI.

107. A computer readable medium as recited in claim 106, wherein said proxy calculations are related to accuracy and precision.

108. A computer readable medium as recited in claim 107, wherein said proxy calculations are based on at least one member of the following group: radio signal bandwidth, radio signal strength, packet delay, packet losses, variability, throughput, jitter, selective availability, and perceived noise level.

109. A computer readable medium as recited in claim 85, wherein a historical map of calculated QoSI's and related location estimates are used in the determination of QoSI's for a given area.

110. A computer readable medium as recited in claim 85, wherein said QoSI is developed periodically.

111. A computer readable medium as recited in claim 85, wherein said QoSI is developed continuously.

112. A computer readable medium as recited in claim 85, wherein said QoSI is determined using received signal information and information about available network-based location technologies.

113. A computer readable medium as recited in claim 85, wherein said QoSI has the form of a bar graph.

114. A computer readable medium as recited in claim 85, wherein said QoSI has the form of a radial graph.

115. A computer readable medium as recited in claim 85, wherein said QoSI has the form of a multi-colored display.

116. A computer readable medium as recited in claim 85, wherein said QoSI has the form of a QoSI element overlaid on a map display.

117. A computer readable medium as recited in claim 85, wherein said QoSI comprises multiple QoSI elements corresponding to multiple location services.

118. A computer readable medium as recited in claim 85, wherein the device further comprises a GPS receiver for self-locating, and wherein the method includes making a periodic QoSI calculation to update the QoSI while the device is idle.

119. A computer readable medium as recited in claim 85, wherein a QoSI associated with a first location technique is employed to predict a QoSI for a second location technique.

120. A computer readable medium as recited in claim 85, wherein the device is adapted to operate in a GSM wireless communications system.

121. A computer readable medium as recited in claim 85, wherein the device is adapted to operate in a UMTS wireless communications system.

122. A computer readable medium as recited in claim 85, wherein the GSM wireless communications system allows for multiple location techniques, including network-based and mobile-based techniques, and the method includes displaying said QoSI based upon the highest accuracy location technology available.

123. A computer readable medium as recited in claim 85, wherein said QoSI further indicates the type of location technology used to provide said location estimation.

124. A computer readable medium as recited in claim 85, wherein said method includes configuring the device to generate an alarm when the QoSI indicates a quality of service below a pre-set threshold.

125. A computer readable medium as recited in claim 124, wherein said method includes configuring the device to provide a mechanism for a user to set said threshold.
